(19) United States
(12) Patent Application Publication
(10) Pub. No.: US 2018/0234358 A1
(43) Pub. Date: Aug. 16, 2018

(54) SYSTEMS AND METHODS FOR PACKET ACQUISITION

(71) Applicant: QUALCOMM Incorporated, San Diego, CA (US)

(72) Inventors: Ondrej Jakubov, Bristol (GB); Sandipan Kundu, Santa Clara, CA (US); Pratima Pai, Bristol (GB)

(21) Appl. No.: 15/429,410

(22) Filed: Feb. 10, 2017

(51) Int. Cl. H04L 12/939; H04W 4/00; H04L 12/823; H04B 17/318; H04L 12/801; H04L 29/06

(52) U.S. Cl. CPC H04L 49/557; H04W 4/008; H04L 47/32; H04L 69/22; H04B 17/318; H04L 47/29; H04L 49/555

(57) ABSTRACT

A method for Bluetooth packet acquisition is described. The method includes performing preamble detection on a received signal using a first set of cross-correlation results. The method also includes delaying packet detection by a delay window when a preamble is detected. The method further includes detecting the Bluetooth packet based on a maximum cross-correlation result of the received signal within a packet search window of a second set of cross-correlation results.

### TECHNICAL FIELD

The present disclosure relates generally to communications. More specifically, the present disclosure relates to systems and methods for packet acquisition.

### BACKGROUND

In the last several decades, the use of wireless communication devices has become common. In particular, advances in electronic technology have reduced the cost of increasingly complex and useful wireless communication devices. Cost reduction and consumer demand have proliferated the use of wireless communication devices such that they are practically ubiquitous in modern society. As the use of wireless communication devices has expanded, so has the demand for new and improved features of wireless communication devices. More specifically, wireless communication devices that perform new functions and/or that perform functions faster, more efficiently or more reliably are often sought after.

Advances in technology have resulted in smaller and more powerful wireless communication devices. For example, there currently exist a variety of wireless communication devices such as portable wireless telephones (e.g., smartphones), personal digital assistants (PDAs), laptop computers, tablet computers and paging devices that are each small, lightweight and can be easily carried by users.

A wireless communication device may make use of one or more wireless communication technologies. For example, a wireless communication device may communicate using Bluetooth technology. A wireless communication device may monitor for Bluetooth packets sent by other Bluetooth devices. However, in some cases, the wireless communication device may incorrectly detect a Bluetooth packet. These packet acquisition errors are referred to as false alarms. Systems and methods for reducing false alarm rate in Bluetooth packet acquisition may be beneficial.

### SUMMARY

A method for Bluetooth packet acquisition is described. The method includes performing preamble detection on a received signal using a first set of cross-correlation results. The method also includes delaying packet detection by a delay window when a preamble is detected. The method further includes detecting the Bluetooth packet based on a maximum cross-correlation result of the received signal within a packet search window of a second set of cross-correlation results.

Performing preamble detection may include computing an absolute value of each sample in the first set of cross-correlation results. A preamble search window may be started when the absolute value of a given sample crosses an early detection threshold. A maximum cross-correlation result may be determined within the preamble search window. Packet detection may be disabled.

A length of the delay window may be determined based on a comparison of an initial cross-correlation result in the preamble search window and the maximum cross-correlation result in the preamble search window. Packet detection may be re-enabled at the end of the delay window.

Detecting the Bluetooth packet may include determining that a Received Signal Strength Indicator (RSSI) of the received signal is greater than an RSSI threshold. A cross-correlation result of a given sample may be determined to be greater than one or more detection thresholds. The one or more detection thresholds may include a first detection threshold and a second detection threshold. The first detection threshold may be the cross-correlation result of the given sample averaged with a leaky integrator. The second detection threshold may be a configurable fixed threshold decreased by a normalized deviation of in-phase and quadrature phase (IQ) components of the given sample.

Detecting the Bluetooth packet may include starting the packet search window of the second set of cross-correlation results upon detecting the Bluetooth packet. A maximum cross-correlation result within the packet search window may be determined. The Bluetooth packet may be determined to arrive at a time corresponding to the maximum cross-correlation result in the packet search window. Secondary peaks in the packet search window may be disregarded as false alarms.

The method may also include providing a position of the maximum cross-correlation result in the packet search window to a symbol timing estimator to estimate initial symbol timing of the Bluetooth packet.

The Bluetooth packet may be a Bluetooth long range (BLR) packet or a Bluetooth Low Energy (BLE) packet.

A wireless communication device configured for Bluetooth packet acquisition is also described. The wireless communication device includes a processor, a memory in communication with the processor, and instructions stored in the memory. The instructions are executable by the processor to perform preamble detection on a received signal using a first set of cross-correlation results. The instructions are also executable by the processor to delay packet detection by a delay window when a preamble is detected. The instructions are further executable by the processor to detect the Bluetooth packet based on a maximum cross-correlation result of the received signal within a packet search window of a second set of cross-correlation results.

A computer-program product for Bluetooth packet acquisition is also described. The computer-program product includes a non-transitory computer-readable medium having instructions thereon. The instructions include code for causing a wireless communication device to perform preamble detection on a received signal using a first set of cross-correlation results. The instructions also include code for causing the wireless communication device to delay packet detection by a delay window when a preamble is detected. The instructions further includes code for causing the wireless communication device to detect the Bluetooth packet based on a maximum cross-correlation result of the received signal within a packet search window of a second set of cross-correlation results.

An apparatus configured for Bluetooth packet acquisition is also described. The apparatus includes means for performing preamble detection on a received signal using a first set of cross-correlation results. The apparatus also includes means for delaying packet detection by a delay window when a preamble is detected. The apparatus further includes means for detecting the Bluetooth packet based on a maximum cross-correlation result of the received signal within a packet search window of a second set of cross-correlation results.

### BRIEF DESCRIPTION OF THE DRAWINGS

FIG. 1 is a block diagram illustrating a wireless communication device configured for packet acquisition;

FIG. 2 is a flow diagram illustrating a method for Bluetooth packet acquisition;

FIG. 3 is an example illustrating a Bluetooth Long Range (BLR) packet structure;

FIGS. 4A and 4B illustrate examples of packet acquisition at low signal-to-noise ratio (SNR) conditions and high SNR conditions;

FIG. 5 is a flow diagram illustrating a method for preamble detection;

FIG. 6 is a flow diagram illustrating a method for packet detection;

FIG. 7 is a block diagram illustrating another configuration of a wireless communication device configured for packet acquisition;

FIG. 8 is a flow diagram illustrating another method for packet acquisition by a wireless communication device;

FIG. 9 is a timing diagram illustrating packet acquisition when a preamble is detected;

FIG. 10 is a timing diagram illustrating packet acquisition when a preamble is not detected;

FIG. 11 is a block diagram illustrating a configuration of an Received Signal Strength Indicator (RSSI) evaluation block;

FIG. 12 is a block diagram illustrating a configuration of a threshold evaluation block;

FIG. 13 is a block diagram illustrating a configuration of a leaky integrator;

FIG. 14 is a block diagram illustrating a configuration of a preamble detector;

FIG. 15 is a block diagram illustrating a configuration of a packet detector; and

FIG. 16 illustrates certain components that may be included within a wireless communication device.

### DETAILED DESCRIPTION

A wireless communication device may communicate using one or more Bluetooth protocols. In some configurations, the wireless communication device may use a low energy Bluetooth protocol. These low energy Bluetooth protocols may include Bluetooth Long Range (BLR), Bluetooth Low Energy (BLE) and Bluetooth Low Energy Long Range (BLELR). It should be noted that the Bluetooth Low Energy protocol includes 1 megabit per second (Mbps) rate, 2 Mbps rate and Long Range rates of 500 kilobits per second (kbps) and 125 kbps. The Low Energy Long Range rates are sometimes referred to as Low Energy Coded rates. In these Bluetooth protocols and other wireless standards, initial signal acquisition is performed on a known repeated bits/signal pattern.

The repetition of the bits/signal leads to significant false packet detection. For example, the wireless communication device may experience early packet detection.

The described systems and methods use two correlators for packet detection. A first correlator may detect the presence of a packet preamble. The second correlator may perform final detection of the packet by using the time difference between peaks. Final detection may be delayed if the packet preamble is detected. The first correlator may be short and the second correlator may be long. The described systems and methods are particularly suitable for Long Rate rates, but not limited to these rates.

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

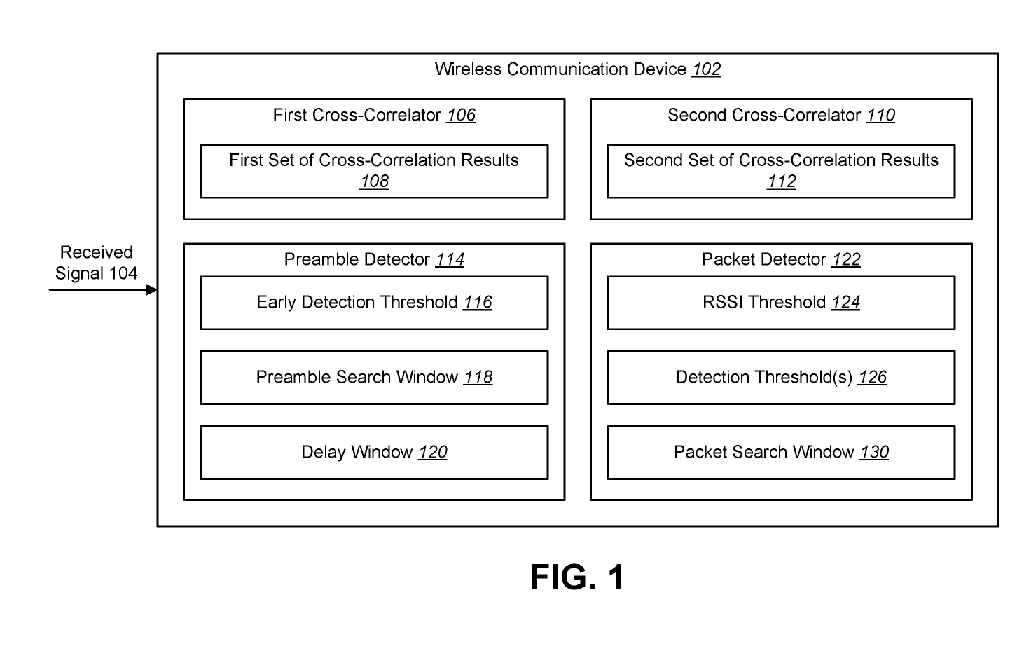

FIG. 1 is a block diagram illustrating a wireless communication device 102 configured for packet acquisition. The wireless communication device 102 may be configured to operate in a wireless communication system. Wireless communication systems are widely deployed to provide various types of communication content such as voice, data, and so on.

Some wireless communication devices 102 may utilize multiple communication technologies or protocols. For example, one communication technology may be utilized for mobile wireless system (MWS) (e.g., cellular) communications, while another communication technology may be utilized for wireless connectivity (WCN) communications. MWS may refer to larger wireless networks (e.g., wireless wide area networks (WWANs), cellular phone networks, Long Term Evolution (LTE) networks, Global System for Mobile Communications (GSM) networks, code division multiple access (CDMA) networks, CDMA2000 networks, wideband CDMA (W-CDMA) networks, Universal mobile Telecommunications System (UMTS) networks, Worldwide Interoperability for Microwave Access (WiMAX) networks, etc.). WCN may refer to relatively smaller wireless networks (e.g., wireless local area networks (WLANs), wireless personal area networks (WPANs), IEEE 802.11 (Wi-Fi) networks, Bluetooth (BT) networks, IEEE 802.15.4 (e.g., Zigbee) networks, wireless Universal Serial Bus (USB) networks, etc.).

Communications in a wireless communication system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication device 102 is an electrical device that is configured to communicate using one or more communication protocols. A wireless communication device 102 may also be referred to as a wireless device, a mobile device, mobile station, subscriber station, client, client station, user equipment (UE), remote station, access terminal, mobile terminal, terminal, user terminal, subscriber unit, etc. Examples of wireless communication devices 102 include laptop or desktop computers, cellular phones, smartphones, wireless modems, e-readers, tablet devices, gaming systems, keyboards, keypads, computer mice, remote controllers, headsets, thermostats, smoke detectors, sensors, etc.

A Bluetooth device may be configured to establish links with one or more target devices that have Bluetooth transceivers. Bluetooth is a packet-based protocol with a master-slave structure. Bluetooth operates in the Industrial, Scientific and Medical (ISM) 2.4 GHz short-range radio frequency band (e.g., 2400-2483.5 MHz). Bluetooth uses a radio technology called frequency-hopping spread spectrum in which transmitted data is divided into packets and each packet is transmitted on a designated Bluetooth frequency (e.g., channel). A packet is a segment of data sent from one device to another device.

Communications in a Bluetooth network may be achieved based on a master polled system. The master polled system may utilize time-division duplexing (TDD) in which a Bluetooth device may send a packet to a target device. For example, a Bluetooth device may send a packet to the target device during pairing or during a connection request. In an implementation, the wireless communication device 102 may be a master device and a target device may be a slave device. In another implementation, the wireless communication device 102 may be a slave device and a target device may be a master device. In a master polled system, the Bluetooth device sending the packet gives the slave device the ability to transmit back.

The Bluetooth wireless communication standard is typically employed for exchanging communications between fixed or mobile Bluetooth-enabled devices over short distances. In some configurations, the systems and methods disclosed herein may be applied to Bluetooth Low Energy (BLE) devices. LE refers to the “Low Energy” extension of the Bluetooth standard. The BLE extension is focused on energy-constrained applications such as battery-operated devices, sensor applications, etc. The BLE extension may also be referred to as Bluetooth Smart.

Another extension of the Bluetooth standard is Bluetooth Long Range (BLR). The BLR extension is also focused on energy-constrained applications. However, BLR may be employed for long range applications. BLR may also be referred to as Bluetooth Low Energy Long Range (BLELR). In an example, an Internet of Things (IoT) device may be a battery-powered sensor configured to transmit over long ranges using BLR.

The following description uses terminology associated with the Bluetooth and Bluetooth LE standards. Nevertheless, the concepts may be applicable to other technologies and standards that involve modulating and transmitting digital data. Accordingly, while some of the description is provided in terms of Bluetooth standards, the systems and methods disclosed herein may be implemented more generally in wireless communication devices that may not conform to Bluetooth standards.

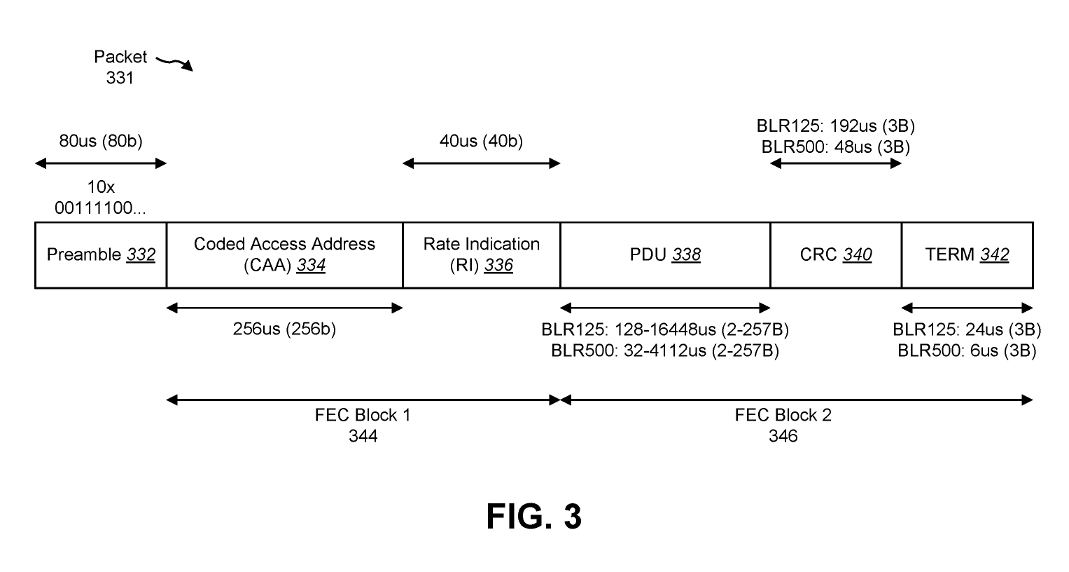

As described above, Bluetooth-enabled devices may exchange information using packets. An example of a packet structure for Bluetooth Long Range (BLR/LELR) is described in connection with FIG. 3. A BLR packet contains a preamble and a Coded Access Address (CAA). The preamble is a pattern (e.g., bit sequence) that is repeated a number of times. In a configuration, the preamble consists of an 8 microsecond (μs) bit sequence that is repeated 10 times.

The wireless communication device 102 may perform packet acquisition on a received signal 104. Packet acquisition is the process of detecting the presence of wanted packets. In addition to packet detection, packet acquisition may include estimating initial symbol timing and estimating the initial carrier frequency offset.

A general approach to packet acquisition includes cross-correlation with a reference sequence. During cross-correlation, the wireless communication device 102 may determine the mutual energy between the received signal 104 and its replica (or reference). In an approach for cross-correlation, a Bluetooth receiver may try to cross-correlate the received signal 104 with a known reference sequence. For example, assuming a known access address of the received packet, the wireless communication device 102 can reconstruct the ideal header of the packet. The wireless communication device 102 may calculate the mutual energy between the received signal 104 and the reference sequence. If the packet is present, then the wireless communication device 102 should receive a peak of this mutual energy.

In this approach, the wireless communication device 102 may compare the received energy against a threshold. The wireless communication device 102 may find when the metric derived from cross-correlation result crosses a preset threshold(s) for final packet decision. If the computed cross-correlation crosses this threshold then the wireless communication device 102 may declare that it has received the packet. The wireless communication device 102 may then determine the initial symbol time, and frequency estimates.

Particular challenges exist for packet detection in BLR, BLE and other low energy communication protocols. A difference between BLR as compared to classic Bluetooth is that the packets are received at significantly lower signal-to-noise ratio (SNR). For example, the SNR at which the wireless communication device 102 operates may be below 0 dB. That means the power of the received noise is larger than or equal to the power of the received signal. This is not the case for the classic Bluetooth modes or low energy (LE) 1 megabit or 2 megabit per second modes, where the receiver typically would operate at larger decibels. This means the received signal 104 (i.e., the received packet) would be considerably stronger in power than the received noise for those modes.

Another problem encountered in BLR and other low energy applications is the unknown amplitude of the received signal 104. In the classic Bluetooth mode and in 1 Mbps and 2 Mbps LE modes, the power is significantly larger than the noise. Therefore, a device can estimate the amplitude of the unwanted signal directly from the received signal without much error. However, when the signal is very close to the noise power, then what is being estimated is the composite of the wanted signal and the noise. The estimate is significantly impacted by the noise. Because of that, there are problems during the cross-correlation. In this case, a fixed threshold cannot be used for packet detection. The energy or the peak energy (i.e., the value of the main peak during the cross-correlation process) is much lower in low SNR conditions.

Yet another challenge in BLR is that the preamble and CAA are repetitive in nature. That is why even in low and high SNR scenarios, there is a chance that a device locks early with the reference sequence and gets locked to the wrong part of the packet. The cross-correlation may produce peaks that are above the fixed threshold. Ideally, a device should look for the peak that is highest. But because of the repeated preamble and CAA there may be secondary peaks that are above the threshold too. Those are the wrong points for packet detection and should be avoided. Therefore, a fixed detection threshold for BLR results in poor performance.

Additionally, high frequency offset and drift should be supported. Another challenge with BLR is that the wireless communication device 102 may have no knowledge about the time of arrival of the packet and impairments of the received signal 104.

Low cost algorithms are another challenge. For example, one important use of BLR is for internet of things (IoT) applications. In these applications, low cost (in terms of productions costs and energy consumption) may be important. Therefore, small to medium length cross-correlators may be beneficial.

Another challenge is supporting a wide range of signal levels. For example, implementing automatic gain control (AGC) with amplitude normalization and/or fixed detection thresholds results in performance loss.

Yet another challenge for BLR is to maximize the probability of detection (PD) at an acceptable probability of false alarm (PFA). As used herein, “false alarm” includes early or late packet detection, or the detection of an unwanted packet. The presence of secondary peaks due to poor correlation properties of the CAA may result in a PFA floor at high SNR. A PFA floor at high SNR results in system throughput degradation.

Given these challenges, desired characteristics for packet detection include the following. A small correlator (for low power and low area) is important in applications where cost is a concern. Another characteristic for packet detection in a BLR case is providing high probability of detection at low SNR and low probability of false alarm at high SNR.

The systems and methods described herein preserve a correlation-based detection architecture for high probability of detection. By additional low-resource means, the described systems and methods minimize the probability of false alarm at high SNR that otherwise occur due to secondary peaks of the cross-correlation as a function of the preamble and CAA.

One aspect of the described systems and methods is an adaptive threshold determination. One or more detection thresholds 126 may be dynamically calculated based on the received signal power averaged over a window of time of the received power. This gives a dynamic threshold. This may be referred to as an adaptive thresholding algorithm. However, because of the secondary peaks (e.g., side lobes), such variable threshold would likely be crossed by one of the secondary peaks, because they can be relatively high in a high SNR scenario. Therefore, the described systems and methods incorporate additional mechanisms to account for false alarms due to secondary peaks.

The wireless communication device 102 may perform preamble detection on the received signal using a first set of cross-correlation results 108. The wireless communication device 102 may be configured with two cross-correlators. A first cross-correlator 106 may perform cross-correlation on a first subset of samples of the received signal 104. In an implementation, the wireless communication device 102 may generate in-phase and quadrature (IQ) samples of the received signal 104. The first cross-correlator 106 may perform cross-correlation on a subset of IQ samples to determine a first set of cross-correlation results 108. The first cross-correlator 106 may compute an absolute value of each sample in the first set of cross-correlation results 108. It should be noted that the cross-correlation may be performed using phase or complex numbers.

The first cross-correlator 106 may provide the first set of cross-correlation results 108 to a preamble detector 114. It should be noted that the first cross-correlator 106 may provide a cross-correlation result for a given sample as it is obtained. In other words, the first cross-correlator 106 may stream the first set of cross-correlation results 108 to the preamble detector 114.

The preamble detector 114 may use the first set of cross-correlation results 108 to determine whether a preamble is detected in the received signal 104. The preamble detection may also be referred to as early detection. The preamble detector 114 may decide on the presence of the preamble. In BLR, the preamble is reliably detected at high SNR. However, at high SNR the BLR packets are subject to early false packet detection. It should be noted that at low SNR, packet misdetection is not dominated by false alarms. Therefore, preamble detection misses are tolerable for low SNR conditions.

The preamble detector 114 may determine whether the absolute value of a given sample in the first set of cross-correlation results 108 crosses an early detection threshold 116. When the absolute value of a given sample in the first set of cross-correlation results 108 crosses an early detection threshold 116, then the preamble detector 114 declares that the preamble is detected. In an implementation, the early detection threshold 116 may be a fixed threshold. In another implementation, the early detection threshold 116 may be adaptive based on the strength of the received signal 104.

Upon detecting the preamble, the preamble detector 114 may delay packet detection for a certain delay window 120. The delay window 120 may be an amount of time that the wireless communication device 102 disables packet detection. The delay window 120 protects from early false peak detection. The delay window 120 allows the wireless communication device 102 to reject nearby false peaks and gives additional allowance for preamble peak detection time uncertainty due to the repetitive pattern of the preamble (e.g., the 10×8 μs periods).

In an implementation, the delay window 120 may be a fixed length. In another implementation, the length of delay window 120 may be determined based on a maximum cross-correlation result within a preamble search window 118.

In an approach, the preamble detector 114 may store the value of a given sample that first crosses the early detection threshold 116. This value may be referred to as an initial metric. The preamble detector 114 may start the preamble search window 118 of a fixed duration. The preamble detector 114 may set an early detection flag that disables the final packet detection by the packet detector 122.

Within the preamble search window 118, the preamble detector 114 may determine a maximum cross-correlation result. For example, the preamble detector 114 may search for a maximum of the absolute value of the first set of cross-correlation results 108 within the preamble search window 118. At the end of the preamble search window 118, the preamble detector 114 may compare the initial metric with the maximum value minus a configurable offset.

The preamble detector 114 may determine a length of the delay window 120 based the comparison of an initial cross-correlation result in the preamble search window 118 and the maximum cross-correlation result in the preamble search window 118. The result of the comparison determines the delay window 120 from the end of the preamble search window 118 until the final packet detection.

In an approach, when the initial metric is greater than the maximum value minus a configurable offset, the delay window 120 is a certain length of time starting from the from the initial early detection threshold 116 cross. In an implementation, the length of time may be a fixed early detection initial symbol offset (earlyDetectionInitSymOffset) plus a configurable time duration. When the initial metric is less than or equal to the maximum value minus the configurable offset, the delay window 120 is a configurable time duration starting from the maximum position.

At the end of the delay window 120, the preamble detector 114 may re-enable packet detection. In an implementation, the preamble detector 114 clears the early detection flag at the end of the delay window 120, thus re-enabling the packet detector 122 to perform packet detection.

A second cross-correlator 110 may also perform cross-correlation on the received signal 104. The second cross-correlator 110 may determine a second set of cross-correlation results 112. The second cross-correlator 110 may provide the second set of cross-correlation results 112 to the packet detector 122.

In an implementation, the second cross-correlator 110 may perform cross-correlation on the full set of samples of the received signal 104. In this implementation, the first set of cross-correlation results 108 as determined by the first cross-correlator 106 are a subset of the second set of cross-correlation results 112 that are determined by the second cross-correlator 110.

In another implementation, the second set of cross-correlation results 112 that are determined by the second cross-correlator 110 may be distinct from the first set of cross-correlation results 108 as determined by the first cross-correlator 106. For example, the first cross-correlator 106 may generate the first set of cross-correlation results 108 from a first set of samples and the second cross-correlator 110 may generate the second set of cross-correlation results 112 from a second set of samples.

In yet another implementation (not shown), a single cross-correlator may generate both the first set of cross-correlation results 108 and the second set of cross-correlation results 112. For example, a single cross-correlator may generate the first set of cross-correlation results 108 for use by the preamble detector 114 and the second set of cross-correlation results 112 for use by the packet detector 122.

The packet detector 122 may detect the Bluetooth packet based on a maximum cross-correlation result of the received signal 104 within a packet search window 130 of the second set of cross-correlation results 112. When packet detection is enabled (e.g., at the end of the delay window 120), the packet detector 122 may compare samples of the received signal 104 against one or more thresholds to determine whether a packet is detected.

In an approach, the packet detector 122 may compare the Received Signal Strength Indicator (RSSI) of the received signal 104 to an RSSI threshold 124. The packet detector 122 may also determine whether a cross-correlation result of a given sample is greater than one or more detection thresholds 126.

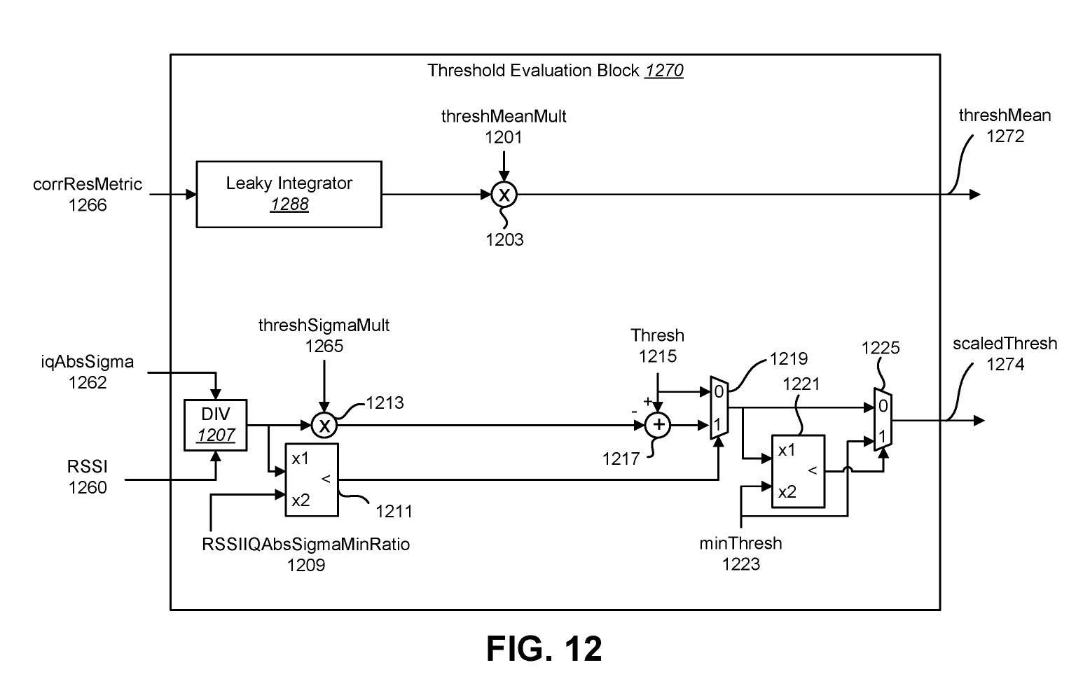

In an implementation, the one or more detection thresholds 126 may include a first detection threshold and a second detection threshold. The first detection threshold may be the cross-correlation result of the given sample averaged with a leaky integrator. The second detection threshold may be a configurable fixed threshold decreased by a normalized deviation of in-phase and quadrature phase (IQ) components of the given sample. The detection thresholds 126 may be dynamic thresholds. In other words, the wireless communication device 102 may adjust the detection thresholds 126 based on the received signal 104. A threshold evaluation approach is described in connection with FIG. 12.

When the packet detector 122 determines that the RSSI of the received signal 104 is greater than the RSSI threshold 124 and the cross-correlation result of a given sample is greater than the one or more detection thresholds 126, the packet detector 122 may declare that the packet is detected.

To account for false alarms (e.g., secondary peaks in the cross-correlation of the received signal 104), the packet detector 122 may start a packet search window 130 of the second set of cross-correlation results 112 upon detecting the Bluetooth packet. The packet search window 130 may be a configurable amount of time starting at the time of packet detection. The packet detector 122 may search for a maximum cross-correlation result within the packet search window 130.

The Bluetooth packet is determined to arrive at the time corresponding to the maximum cross-correlation result in the packet search window 130. The position of the maximum cross-correlation result in the packet search window 130 may be provided to a symbol timing estimator.

The packet detector 122 may disregard secondary peaks in the packet search window 130 as false alarms. Therefore, the wireless communication device 102 may lock onto the main peak corresponding to the maximum cross-correlation result. The wireless communication device 102 may disregard other peaks that cross the detection thresholds 126.

It should be noted that for low SNR conditions, the wireless communication device 102 may implement a different packet detection approach. In the case of low SNR, the high peaks and false (secondary) peaks in the cross-correlation are significantly lower than with high SNR conditions. Therefore, the side lobes (i.e., secondary peaks) diminish in the noise. For low SNR conditions where the packet is not detected, a dynamic detection threshold 126 may be sufficient to detect a main peak. Therefore, if the preamble detector 114 does not detect a preamble, then the wireless communication device 102 may assume that low SNR conditions are present. In this low SNR case, the side lobes are not a problem. To detect the packet, the wireless communication device 102 may keep a dynamic thresholding algorithm running without disabling the packet detector 122. An example of a dynamic threshold is described in connection with FIG. 12.

It should be noted that the described systems and methods utilize a state machine-type approach to packet detection. If a preamble is detected, the wireless communication device 102 enters a high SNR state. The preamble detector 114 initiates a delay window 120, which disables packet detection for a period of time. If the preamble is not detected, then the wireless communication device 102 enters a low SNR state in which the wireless communication device 102 continues to perform dynamic detection thresholding without disabling the packet detection.

It should be noted that although the systems and methods are described in terms of BLE, the described early detection algorithms are also applicable to other Bluetooth Low Energy modes.

The systems and methods described herein provide the following benefits. False alarms for high SNR conditions are practically eliminated. A high probability of detection at low SNR is achieved using cross-correlation-based packet detection. Variable input signal levels are supported. The described systems and methods also provide small additional latency compared to cross-correlation only architecture, determined by final packet search window 130.

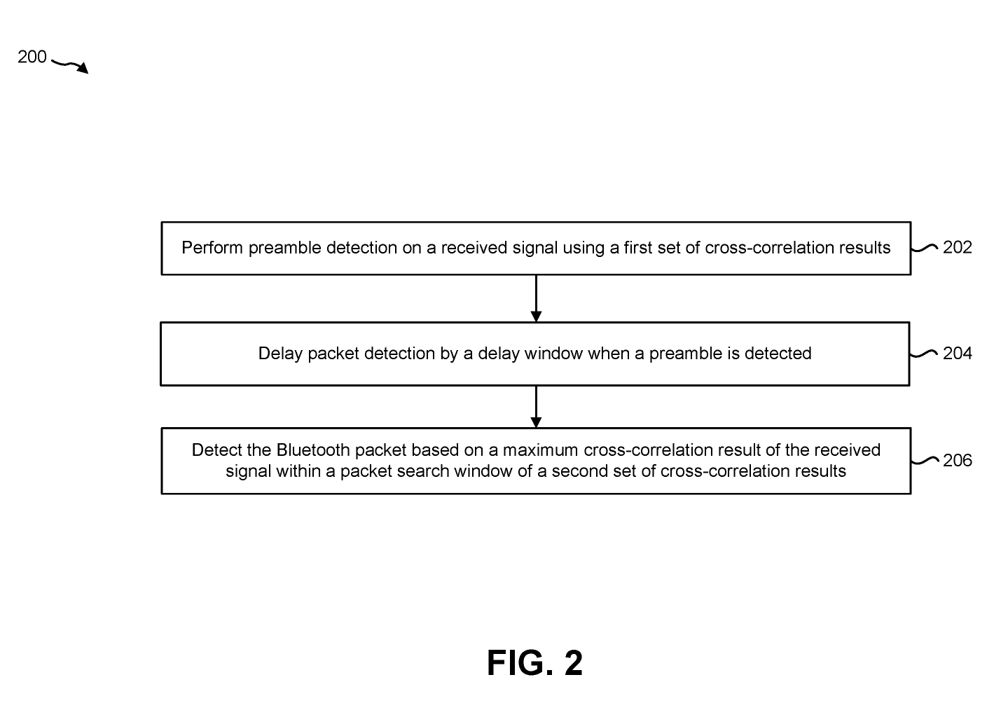

FIG. 2 is a flow diagram illustrating a method 200 for Bluetooth packet acquisition. The method 200 may be implemented by a wireless communication device 102. The wireless communication device 102 may be configured to perform packet detection upon receiving a signal 104. The Bluetooth packet may be a Bluetooth long range (BLR) packet or a Bluetooth Low Energy (BLE) packet.

The wireless communication device 102 may perform 202 preamble detection on the received signal 104 using a first set of cross-correlation results 108. The wireless communication device 102 may include two cross-correlators. A first cross-correlator 106 may perform cross-correlation on a first subset of samples of the received signal 104. The first cross-correlator 106 may provide the first set of cross-correlation results 108 to a preamble detector 114.

The wireless communication device 102 may delay 204 packet detection by a delay window 120 when a preamble is detected. For example, the preamble detector 114 may monitor whether the absolute value of a given sample in the first set of cross-correlation results 108 crosses an early detection threshold 116. When a sample crosses the early detection threshold 116, the wireless communication device 102 may disable packet detection for a delay window 120. This may prevent the wireless communication device 102 from detecting false peaks in the cross-correlation of the received signal 104 in high SNR conditions.

The wireless communication device 102 may detect 206 the Bluetooth packet based on a maximum cross-correlation result of the received signal 104 within a packet search window 130 of a second set of cross-correlation results 112. The second cross-correlator 110 may determine the second set of cross-correlation results 112. The second cross-correlator 110 may provide the second set of cross-correlation results 112 to a packet detector 122.

At the end of the delay window 120, the packet detector 122 may determine that a cross-correlation result of a given sample is greater than one or more detection thresholds 126. The packet detector 122 may start a packet search window 130. The packet detector 122 may search the second set of cross-correlation results 112 within the packet search window 130 for a maximum cross-correlation result. The Bluetooth packet is determined to arrive at a time corresponding to the maximum cross-correlation result in the packet search window 130.

FIG. 3 is an example illustrating a Bluetooth Long Range (BLR) packet structure. The BLR packet 331 includes a preamble 332, coded access address (CAA) 334, a rate indication (RI) 336, a Protocol Data Unit (PDU) 338, Cyclic Redundancy Check (CRC) 340 and a terminal block (TERM) 342. The TERM 342 may insert 0 to terminate an FEC Block 346. The zeros guarantee that the encoder returns to the initial state at any combination of previous bits. This may terminate packets that use convolutional codes.

The CAA 334 and RI 336 are included in a first forward error correction (FEC) block 344. The PDU 338, CRC 340 and TERM 342 are included in a second forward error correction (FEC) block 346.

With Bluetooth, there are multiple modes that may be supported. BLR may be 500 kilobits per second or 125 kilobits per second. In BLR, the preamble 332 and CAA 334 structure is different from the BLE 1 megabit per second mode, which has a different preamble and just an access address. Both the 125 k (BLR125) and 500 k (BLR500) have the same preamble 332 and CAA 334.

The major change in the structure of the BLR packet 331 is that the header part (preamble 332, CAA 334 and RI 336) is much longer. This enables the receiver to receive the packet 331 at much lower input power. In this case, there is more energy in the signal from which to acquire the packet 331.

In BLR, the packet 331 has been designed with a preamble 332 that is 80 microseconds (us) (80 bits), which is composed of a repetitive pattern. The packet 331 repeats 4 ones and 4 zeros, 4 microseconds of ones and 4 microseconds of zeros for a period of 8 microseconds. That period then repeats ten times, which gives an 80 microsecond preamble 332.

The CAA 334 is made up of the original LE 1 megabit per second 32-bit access address, which is encoded into a 256-bit coded access address. This takes 256 microseconds. The encoding of the CAA 334 may be done through a forward error correction code, which has a rate of 2 to 1 (i.e., 1 input bits to 2 output bit). Then this is further encoded with a pattern number, one input bits to 4 output bits. So in total, for one input bit, there are 8 output bits. A 32-bit access address generates a 256 bit coded access address 334.

The last part of the header is the rate indication (RI) 336. This is a sequence of either 1 and 0 fours, or 5 zeros, encoded in the same way as the coded access address 334. It means using the forward error correction and number. This is to tell whether the packet 331 is going to be 125 kilobits per second, or 500 kilobits per second. The payload (PDU 338) continues at either 500 kilobits or 125 kilobits per second.

Regarding the acquisition problem described in connection with FIG. 1. The wireless communication device 102 first tries to detect the presence of the packet 331 within the received signal 104. The wireless communication device 102 also tries to estimate exactly when the packet 331 is arriving in time, and the initial frequency of the packet 331.

It should be noted that the preamble 332 and the CAA 334 are known to the receiving wireless communication device 102. The preamble 332 is fixed for all packets 331. The CAA 334 may employ a fixed encoding of 32-bit Access Address (AA). At the beginning of the communication between the receiver and the transmitter, the AA is known to be advertising AA of a fixed pattern. This serves to initiate the link. The information of the subsequent AA is exchanged between the transmitter and receiver and such AA is used subsequently during the link existence. Such AA is known to be data AA. The arrangement of bits in the data AA follows specific rules described the BT SIG specification. Therefore, the wireless communication device 102 can use the preamble 332 and the CAA 334 for packet detection, initial symbol timing and frequency estimation.

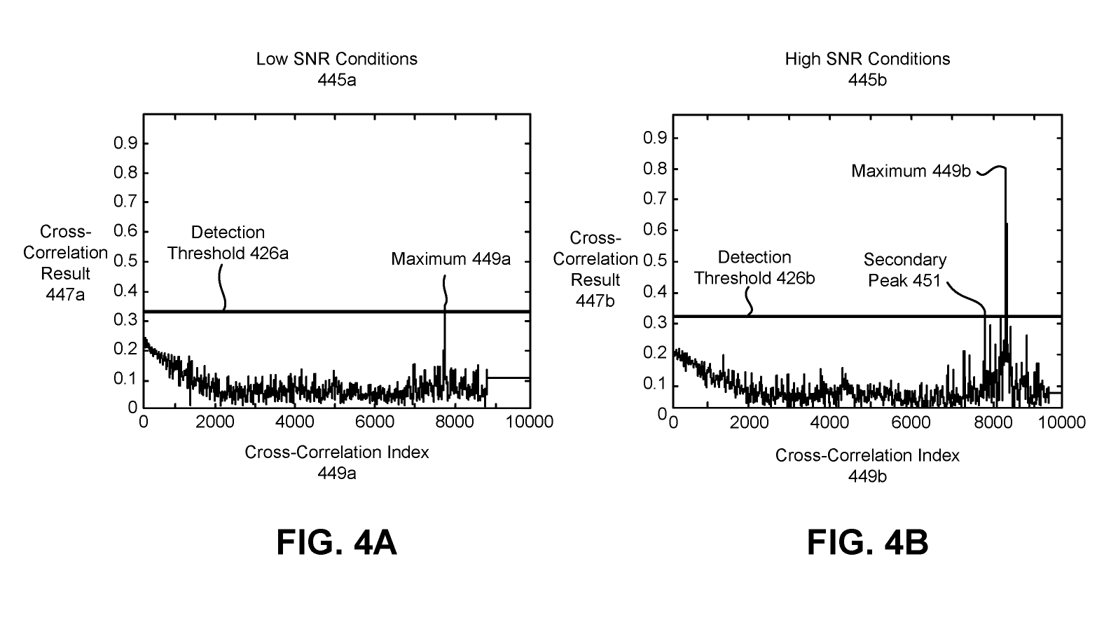

FIGS. 4A and 4B illustrate examples of packet acquisition at low signal-to-noise ratio (SNR) conditions 445a and high SNR conditions 445b. FIG. 4A depicts low SNR cross-correlation results 447a. The cross-correlation results 447a for a number of samples are shown relative to a cross-correlation index 449a. The packet may be detected when a maximum cross-correlation result 447a crosses a detection threshold 426a. In this example, the maximum cross-correlation result 447a crosses the detection threshold 426a at approximately sample 7740.

It should be noted that in the low SNR conditions 445a case, the packet detection is not dominated by false alarms. In other words, for low SNR conditions 445a, false secondary peaks are not likely and packet detection may be performed using dynamic thresholding.

An example of high SNR cross-correlation results 447b is depicted in FIG. 4B. The cross-correlation results 447b for a number of samples are shown relative to a cross-correlation index 449b.

In the case of high SNR, a maximum cross-correlation result 447b crosses the detection threshold 426b. However, multiple secondary peaks 451 also cross the detection threshold 426b. This illustrates the problem of false alarm at high SNR conditions 445b. At high SNR conditions 445b there is potential of signal lock to an early peak 451 that crosses the detection threshold 426b before the maximum cross-correlation result 447b. For example, a secondary peak 451 at approximately sample 7780 crosses the detection threshold 426b before the maximum 449b at approximately sample 8300. This demonstrates the need for suppressing false alarm and adaptive detection threshold(s) 426b at high SNR.

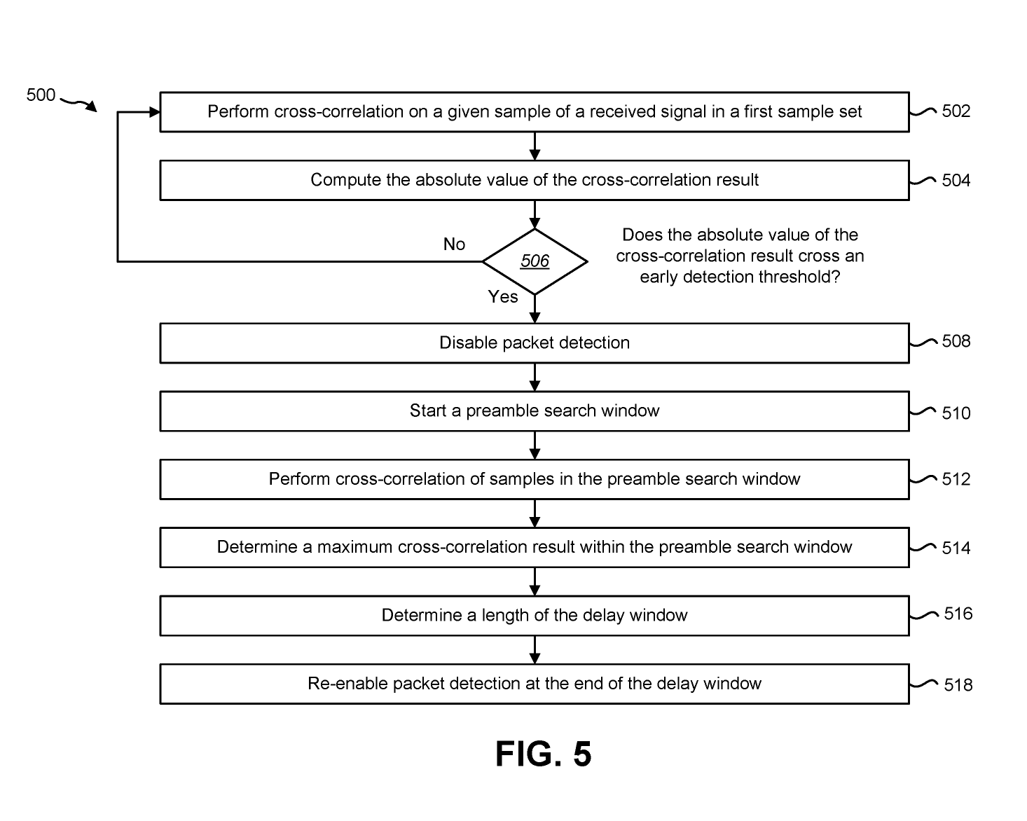

FIG. 5 is a flow diagram illustrating a method 500 for preamble detection. The method 500 may be implemented by a wireless communication device 102. The preamble 332 may be part of a BLR packet 331.

The wireless communication device 102 may receive a signal 104. The wireless communication device 102 may perform 502 cross-correlation on a given sample of the received signal 104 in a first sample set. For example, the wireless communication device 102 may determine the in-phase and quadrature phase (IQ) components of a sample of the received signal 104. A first cross-correlator 106 may perform cross-correlation on a first subset of samples of the received signal 104. The first set of cross-correlation results 108 may be a short set corresponding to a number of samples in the preamble 332 of a packet 331.

The wireless communication device 102 may compute 504 the absolute value of the cross-correlation result. This provides the magnitude of the cross-correlation result.

The wireless communication device 102 may determine 506 whether the absolute value of the cross-correlation result crosses an early detection threshold 116. If the absolute value of the cross-correlation result is less than or equal to the early detection threshold 116, then the wireless communication device 102 may perform 502 cross-correlation on the next sample of the received signal 104.

If the absolute value of the cross-correlation result is greater than the early detection threshold 116, then the wireless communication device 102 may disable 508 packet detection. For example, the wireless communication device 102 may start a delay window 120, during which, a packet detector 122 is disabled.

The wireless communication device 102 may start 510 a preamble search window 118. The wireless communication device 102 may perform 512 cross-correlation of the samples in the preamble search window 118. At the end of the preamble search window 118, the wireless communication device 102 may determine 514 a maximum cross-correlation result within the preamble search window 118.

The wireless communication device 102 may determine 516 a length of the delay window 120. For example, the wireless communication device 102 may determine 516 a length of the delay window 120 based on a comparison of an initial cross-correlation result in the preamble search window 118 and the maximum cross-correlation result in the preamble search window 118. The initial cross-correlation result may be the first cross-correlation result to cross the early detection threshold 116.

In an implementation, if the maximum cross-correlation result minus the initial cross-correlation result is above a configurable offset, then the length of the delay window 120 may be defined from the maximum position in the preamble search window 118 plus a configurable time duration. Otherwise, the length of the delay window 120 may be defined from the initial early detection threshold 116 plus a configurable time duration.

At the end of the delay window 120, the wireless communication device 102 may re-enable 518 packet detection. For example, the wireless communication device 102 may re-enable the packet detector 122 to continue packet detection.

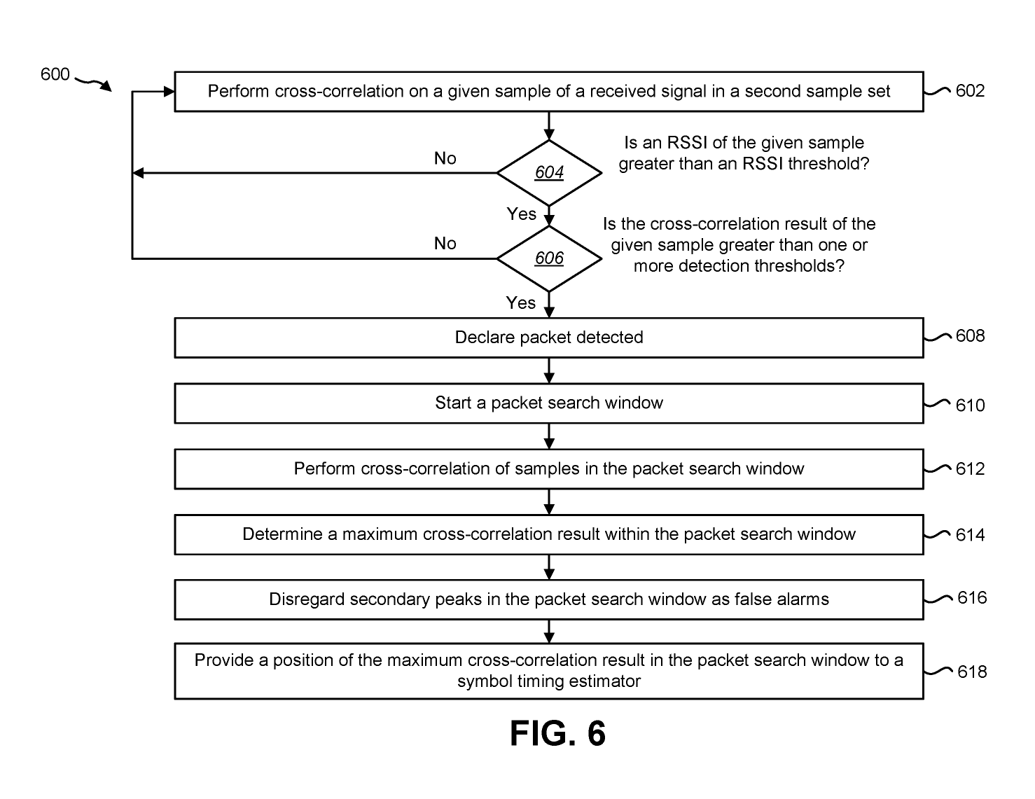

FIG. 6 is a flow diagram illustrating a method 600 for packet detection. The method 600 may be implemented by a wireless communication device 102. The packet detection may be enabled and/or disabled as described in connection with FIG. 5.

The wireless communication device 102 may receive a signal 104. The wireless communication device 102 may perform 602 cross-correlation on a given sample of the received signal 104 in a second sample set. For example, the wireless communication device 102 may determine the in-phase and quadrature phase (IQ) components of sample of the received signal 104. A second cross-correlator 110 may perform cross-correlation on a second subset of samples of the received signal 104. It should be noted that the second set of cross-correlation results 112 may be longer than the first set of cross-correlation results 108 used for preamble detection.

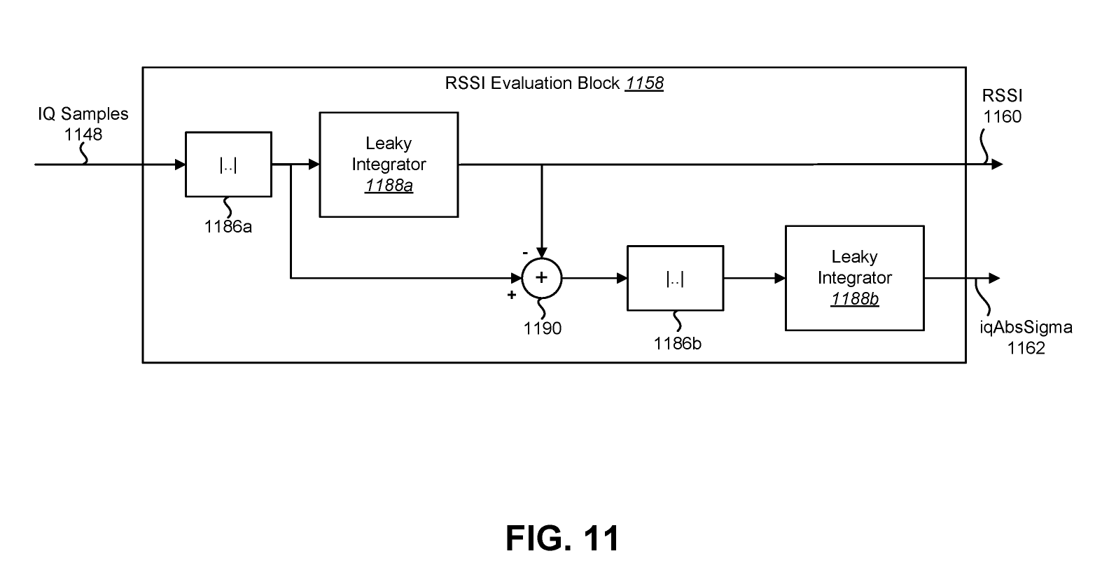

The wireless communication device 102 may determine 604 whether an RSSI is greater than an RSSI threshold 124. For example, the wireless communication device 102 may determine the RSSI of the received signal 104 using IQ samples. The wireless communication device 102 may compare the RSSI to an RSSI threshold 124 to determine whether the IQ samples have enough power. If the RSSI is less than or equal to the RSSI threshold 124, then the wireless communication device 102 may perform 602 cross-correlation on the next sample of the received signal 104. An approach for RSSI evaluation is described in connection with FIG. 11.

If the RSSI is greater than the RSSI threshold 124, then the wireless communication device 102 may determine 606 whether the cross-correlation result of the given sample is greater than one or more detection thresholds 126. In an implementation, the detection thresholds 126 include a first detection threshold and a second detection threshold. The first detection threshold may be the cross-correlation result of the given sample averaged with a leaky integrator. The second detection threshold may be a configurable fixed threshold decreased by a normalized deviation of IQ components of the given sample. An approach for threshold evaluation is described in connection with FIG. 12.

If the cross-correlation result of the given sample is less than or equal to the one or more detection thresholds 126, then the wireless communication device 102 may perform 602 cross-correlation on the next sample of the received signal 104. If the cross-correlation result of the given sample is less than or equal to the one or more detection thresholds 126, then the wireless communication device 102 may declare 608 that the packet 331 is detected.

The wireless communication device 102 may start 610 a packet search window 130. The wireless communication device 102 may perform 612 cross-correlation of the samples in the packet search window 130. At the end of the packet search window 130, the wireless communication device 102 may determine 614 a maximum cross-correlation result within the packet search window 130. The wireless communication device 102 may disregard 616 secondary peaks in the packet search window 130 as false alarms.

The wireless communication device 102 may provide 618 a position of the maximum cross-correlation result in the packet search window 130 to a symbol timing estimator. The Bluetooth packet 331 is estimated to arrive at the time of maximum cross-correlation result in the packet search window 130 minus a correlation offset. The correlation offset is the index of the last sample of the second correlation reference times the symbol period. The index counts from 1, 2, and so on.

It should be noted that this is to account for the fact that at the time the peak is detected, some part of the packet 331 has already been received (excluding payload). The symbol timing estimator may use the position of the maximum cross-correlation result to estimate initial symbol timing of the Bluetooth packet 331.

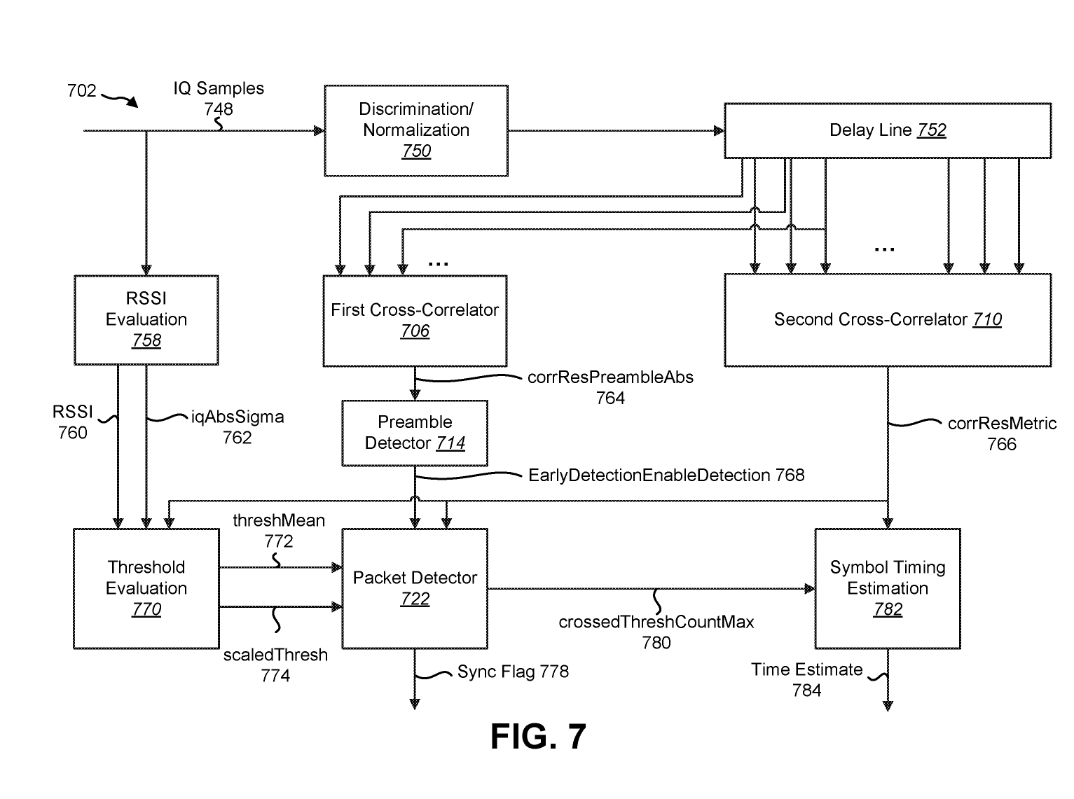

FIG. 7 is a block diagram illustrating another configuration of a wireless communication device 702 configured for packet acquisition. The wireless communication device 702 may generate IQ samples 748 from a received signal 104. The IQ samples 748 may be in the baseband.

A discrimination/normalization block 750 may receive the IQ samples 748. The discrimination/normalization block 750 may transform the signal from the IQ domain into the frequency trajectory. For example, the discrimination/normalization block 750 may differentiate the phase of the IQ samples 748 to get the instant frequency.

The delay line 752 may be a buffer that keeps a history of the IQ samples 748. The delay line 752 may store IQ samples 748 for the period that is needed for the cross-correlation in the first cross-correlator 706 and the second cross-correlator 710. It should be noted that sharing the delay line 752 for early and final cross-correlation may lower implementation costs.

The first cross-correlator 706 may receive a subset of samples from the delay line 752. It should be noted that the subset of samples used by the first cross-correlator 706 for preamble detection may be less than the complete set of samples received by the second cross-correlator 710 for use in packet detection. This is due to the preamble 332 being a subcomponent of the packet header.

The first cross-correlator 706 may perform cross-correlation on the samples received from the delay line 752. The first cross-correlator 706 may output the absolute value of the cross-correlation result (corrResPreambleAbs) 764.

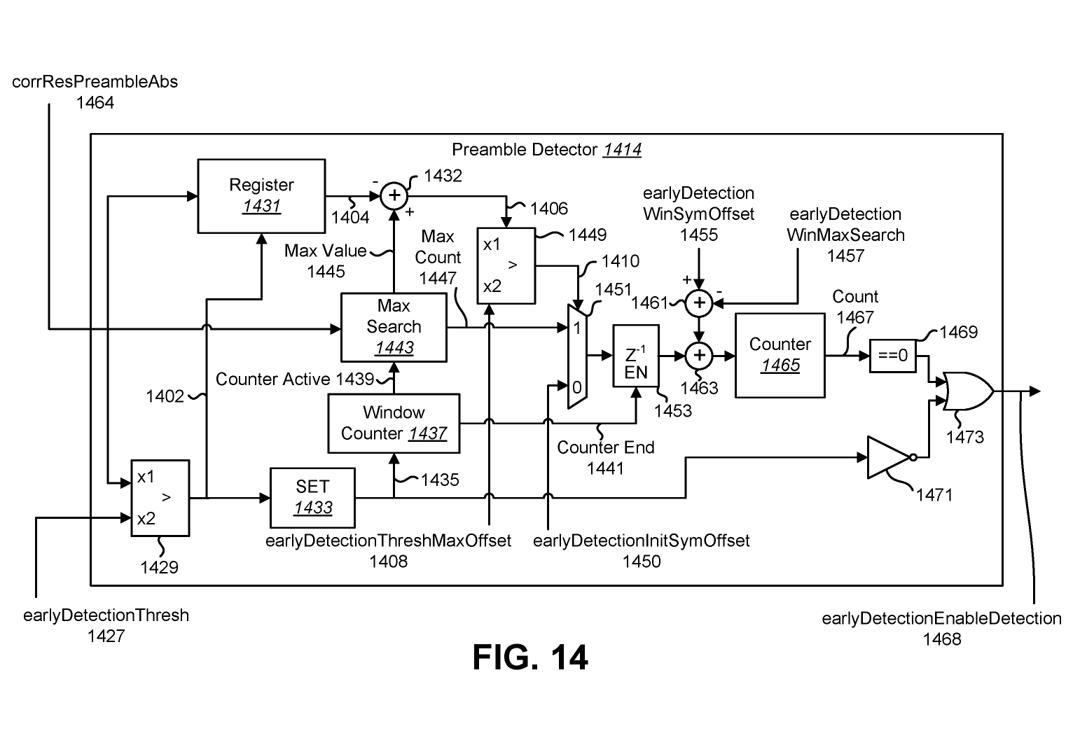

The preamble detector 714 receives the absolute value of the cross-correlation result 764 from the first cross-correlator 706. The preamble detector 714 may perform preamble detection on the received signal 104 using a first set of cross-correlation results 108 provided by the first cross-correlator 706. An implementation of the preamble detector 714 is described in connection with FIG. 14.

The preamble detector 714 may enable and disable packet detection by the packet detector 722. The preamble detector 714 may provide an enable packet detection signal (EarlyDetectionEnableDetection) 768 to the packet detector 722. When EarlyDetectionEnableDetection 768 is set to 1, packet detection is enabled. If the preamble detector 714 determines that the absolute value of the cross-correlation result 764 crosses an early detection threshold 116, the preamble detector 714 may set EarlyDetectionEnableDetection 768 to 0, thus disabling packet detection.

The preamble detector 714 may start a delay window 120 during which EarlyDetectionEnableDetection 768 remains at 0 and packet detection is disabled. The preamble detector 714 may determine the length of the delay window 120. This may be accomplished as described in connection with FIG. 14. At the end of the delay window 120, the preamble detector 714 may set EarlyDetectionEnableDetection 768 to 1, thus re-enabling packet detection.

The second cross-correlator 710 may generate a second set of cross-correlation results 112. For a given IQ sample 748 provided by the delay line 752, the second cross-correlator 710 may determine a cross-correlation result (corrResMetric) 766. The second cross-correlator 710 may provide the corrResMetric 766 to a threshold evaluation block 770, the packet detector 722 and a symbol timing estimation block 782.

An RSSI evaluation block 758 may determine the RSSI 760 of the IQ samples 748. The RSSI evaluation block 758 may also estimate the deviation (iqAbsSigma) 762 from RSSI 760 for the current IQ sample 748. In an implementation, iqAbsSigma 762 may be the averaged distance of the current magnitude of the IQ sample 748 from the average RSSI 760. An implementation of the RSSI evaluation block 758 is described in connection with FIG. 11.

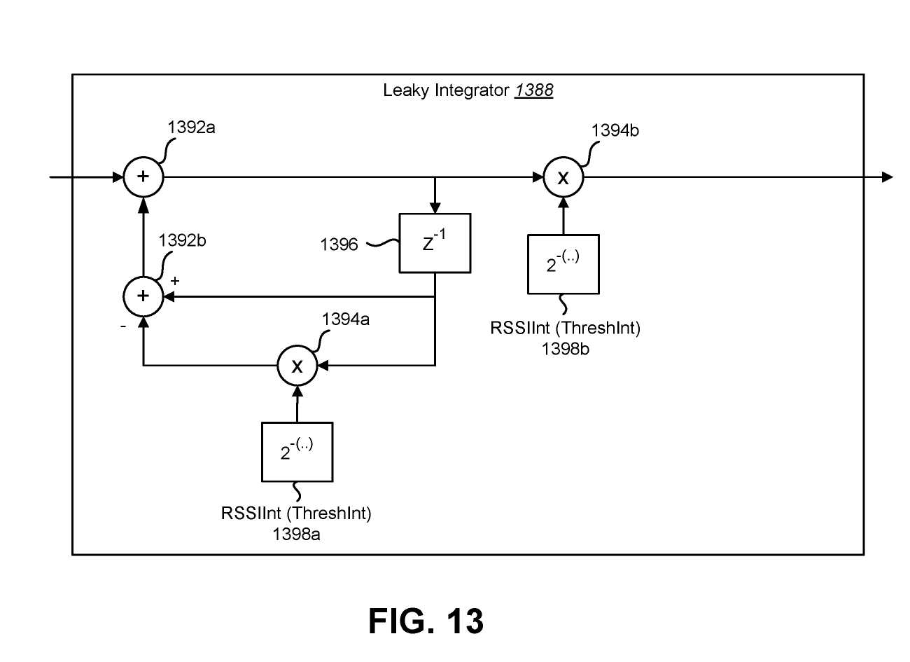

A threshold evaluation block 770 may generate detection thresholds for a given IQ sample 748 based on the RSSI 760, iqAbsSigma 762 and the corrResMetric 766. A first detection threshold (threshMean) 772 is generated by averaging corrResMetric 766 with a leaky integrator. A second detection threshold (scaledThresh) 774 is a configurable fixed threshold decreased by a normalized deviation of the IQ samples 748. An implementation of the threshold evaluation block 770 is described in connection with FIG. 12. An implementation of a leaky integrator is described in connection with FIG. 13.

The packet detector 722 may detect a Bluetooth packet. Packet detection is enabled when EarlyDetectionEnableDetection 768 is 1 and disabled when EarlyDetectionEnableDetection 768 is 0. The packet is detected when the IQ samples 748 have enough power and the cross-correlation metric is above the thresholds threshMean 772 and scaledThresh 774. For example, the packet detector 722 may determine whether the RSSI 760 is greater than an RSSI threshold 124. The packet detector 722 may also determine whether the corrResMetric 766 is greater than threshMean 772 and scaledThresh 774.

If the packet detector 722 detects a packet, the packet detector 722 may indicate the packet by setting a sync flag 778 to 1. When no packet is detected, the sync flag 778 is set to 0.

Upon detecting the packet, the packet detector 722 may start a packet search window 130. The packet detector 722 may determine the maximum value of the corrResMetric 766 within the packet search window 130. The maximum value of the corrResMetric 766 corresponds to the main peak of the cross-correlation results. The packet detector 722 may save the maximum cross-correlation result position (crossedThreshCountMax) 780.

The packet detector 722 may provide the crossedThreshCountMax 780 to the symbol timing estimation block 782. The symbol timing estimation block 782 may determine a time estimate 784 using the crossedThreshCountMax 780 and the corrResMetric 766.

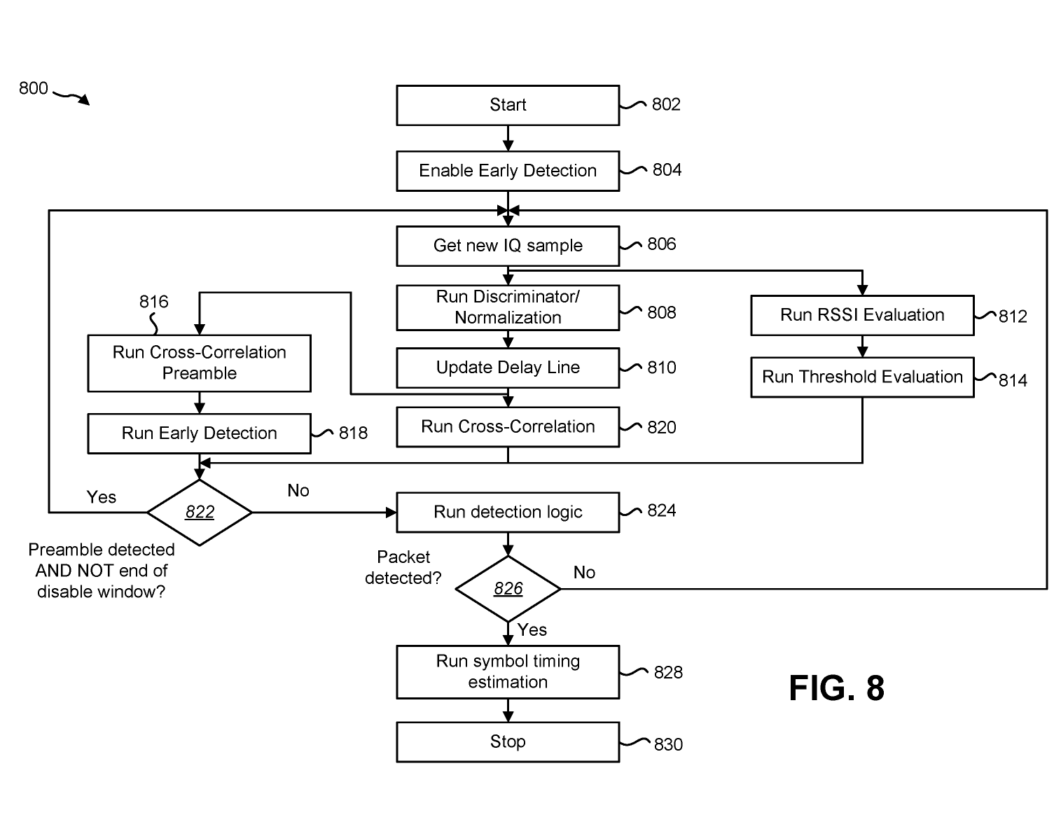

FIG. 8 is a flow diagram illustrating another method 800 for packet acquisition by a wireless communication device 702. The wireless communication device 702 may start 802 the method 800 upon receiving a signal 104.

The wireless communication device 702 may enable 804 early detection. For example, the wireless communication device 702 may set EarlyDetectionEnableDetection 768 to 1. This enables the packet detector 722 to perform packet detection.

The wireless communication device 702 may get 806 a new IQ sample 748 of the received signal 104. The wireless communication device 702 may run 808 discrimination/normalization to transform the IQ sample 748 from the IQ domain into the frequency trajectory. The wireless communication device 702 may update 810 the delay line 752 with the discriminated/normalized signal. Also, upon getting 806 a new IQ sample, the wireless communication device 702 may run 812 an RSSI evaluation to determine the RSSI 760 of the IQ samples 748. The wireless communication device 702 may run 814 a threshold evaluation to determine one or more detection thresholds 126 (e.g., threshMean 772 and scaledThresh 774).

Upon updating 810 the delay line 752, the wireless communication device 702 may run 816 preamble cross-correlation. For example, a first cross-correlator 706 may receive a subset of samples from the delay line 752. The first cross-correlator 706 may perform cross-correlation on the subset of samples. The first cross-correlator 706 may output the absolute value of the cross-correlation result (corrResPreambleAbs) 764.

The wireless communication device 702 may run 818 early detection of a preamble 332 of the packet 331. For example, if the preamble detector 714 determines that the corrResPreambleAbs 764 crosses an early detection threshold 116, the preamble detector 714 may set EarlyDetectionEnableDetection 768 to 0, thus disabling packet detection. If the preamble 332 is detected, the wireless communication device 702 may start a delay window 120. At the end of the delay window 120, the wireless communication device 702 may set EarlyDetectionEnableDetection 768 to 1, re-enabling packet detection.

The wireless communication device 702 may also run 820 a second cross-correlation. For example, a second cross-correlator 710 may generate a second set of cross-correlation results 112. For a given IQ sample 748 provided by the delay line 752, the second cross-correlator 710 may determine a cross-correlation result (corrResMetric) 766.

The wireless communication device 702 may determine 822 whether a preamble 332 was detected and whether it is not at the end of the delay window 120. If this is the case, then EarlyDetectionEnableDetection 768 is currently 0 and packet detection is disabled. The wireless communication device 702 may get 806 a new IQ sample 748.

If the wireless communication device 702 determines 822 that a preamble 332 was not detected or the delay window 120 has ended, then EarlyDetectionEnableDetection 768 is currently 1 and packet detection is enabled. The wireless communication device 702 may run 824 detection logic. For example, a packet detector 722 may compare the RSSI 760 with an RSSI threshold 124. The packet detector 722 may also compare the corrResMetric 766 against the one or more detection thresholds 126.

The wireless communication device 702 may determine 826 whether a packet 331 is detected. For example, when the RSSI 760 is greater than an RSSI threshold 124 and the corrResMetric 766 is greater than threshMean 772 and scaledThresh 774, then the packet 331 is detected. If no packet 331 is detected, the wireless communication device 702 may get 806 a new IQ sample 748. When the packet 331 is detected, the packet detector 722 may indicate the packet by setting a sync flag 778 to 1.

The wireless communication device 702 may determine the maximum cross-correlation result of the received signal 104 within a packet search windows 130. For example, the packet detector 722 may start a packet search window 130. The packet detector 722 may determine the maximum value of the corrResMetric 766 within the packet search window 130. The maximum value of the corrResMetric 766 corresponds to the main peak of the cross-correlation results. The packet detector 722 may save the maximum cross-correlation result position (crossedThreshCountMax) 780.

The wireless communication device 702 may run 828 a symbol timing estimation. For example, the packet detector 722 may provide the crossedThreshCountMax 780 to the symbol timing estimation block 782. The symbol timing estimation block 782 may determine a time estimate 784 using the crossedThreshCountMax 780 and the corrResMetric 766. The method 800 may then stop 830.

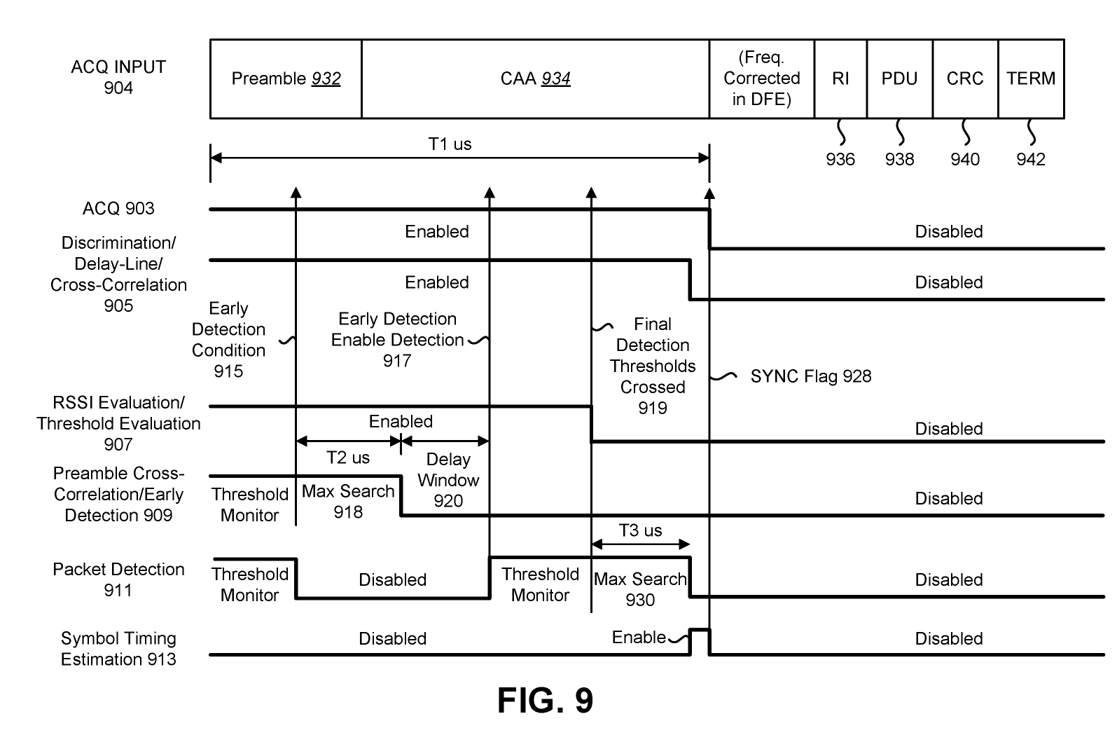

FIG. 9 is a timing diagram illustrating packet acquisition when a preamble 932 is detected. An acquisition (ACQ) input 904 may be a BLR packet that includes a preamble 932, CAA 934, RI 936, PDU 938, a CRC 940 and a TERM 942.

The discrimination/delay-line/cross-correlation 905 waveform corresponds to the activity of the discrimination/normalization block 750, the delay line 752 and the second cross-correlator 710. The RSSI evaluation/threshold evaluation 907 waveform corresponds to the activity of the RSSI evaluation block 758 and the threshold evaluation block 770. The preamble cross-correlation/early detection 909 waveform corresponds to the activity of the first cross correlator 706 and the preamble detector 714. The packet detection 911 waveform corresponds to the activity of the packet detector 722. The symbol timing estimation 913 waveform corresponds to the activity of the symbol timing estimation block 782.

Upon receiving the signal 904, packet acquisition (ACQ) 903 is enabled for a certain period of time (T1 μs). Discrimination/delay-line/cross-correlation 905 and RSSI evaluation/threshold evaluation 907 are also enabled. Preamble cross-correlation/early detection 909 and packet detection 911 are enabled in a threshold monitor state. The symbol timing estimation 913 is disabled.

While monitoring the early detection threshold 116, an early detection condition 915 is detected by the preamble cross-correlation/early detection 909. For example, the preamble detector 714 may determine that the absolute value of the cross-correlation result 764 provided by the first cross-correlator 706 crosses the early detection threshold 116. Packet detection 911 is disabled by the preamble detector 714. For example, the preamble detector 714 may set EarlyDetectionEnableDetection 768 to 0.

At this point, the preamble cross-correlation/early detection 909 enters a maximum search phase 918. The preamble detector 714 may start a preamble search window for a period of time (T2 μs). The preamble detector 714 may determine the maximum value of the cross-correlation result 764 provided by the first cross-correlator 706 within the max search window 918. The preamble detector 714 may determine a delay window 920 for packet detection 911.

At the end of the delay window 920, early detection enable detection 917 occurs. The preamble detector 714 re-enables packet detection 911. For example, the preamble detector 714 may set EarlyDetectionEnableDetection 768 to 1.

When packet detection 911 is re-enabled, the packet detection 911 enters a threshold monitoring state. For example, the packet detector 722 may determine whether the RSSI 760 crosses the RSSI threshold 124. The packet detector 722 may also determine whether a given cross-correlation result crosses the one or more detection thresholds 126.

When final detection thresholds are crossed 919, the RSSI evaluation/threshold evaluation 907 is disabled. The packet detection 911 enters a maximum search phase 930. For example, the packet detector 722 may start a packet search window 930 for a period of time (T3 μs).

At the end of the maximum search phase 930, symbol timing estimation 913 is enabled. The packet detector 722 may provide the maximum cross-correlation result position (crossedThreshCountMax) 780 to the symbol timing estimation block 782. Packet detection 911 and discrimination/delay-line/cross-correlation 905 are then disabled.

The symbol timing estimation block 782 may determine a time estimate 784. A sync flag 978 may indicate that a packet was detected. Symbol timing estimation 913 and ACQ 903 are then disabled.

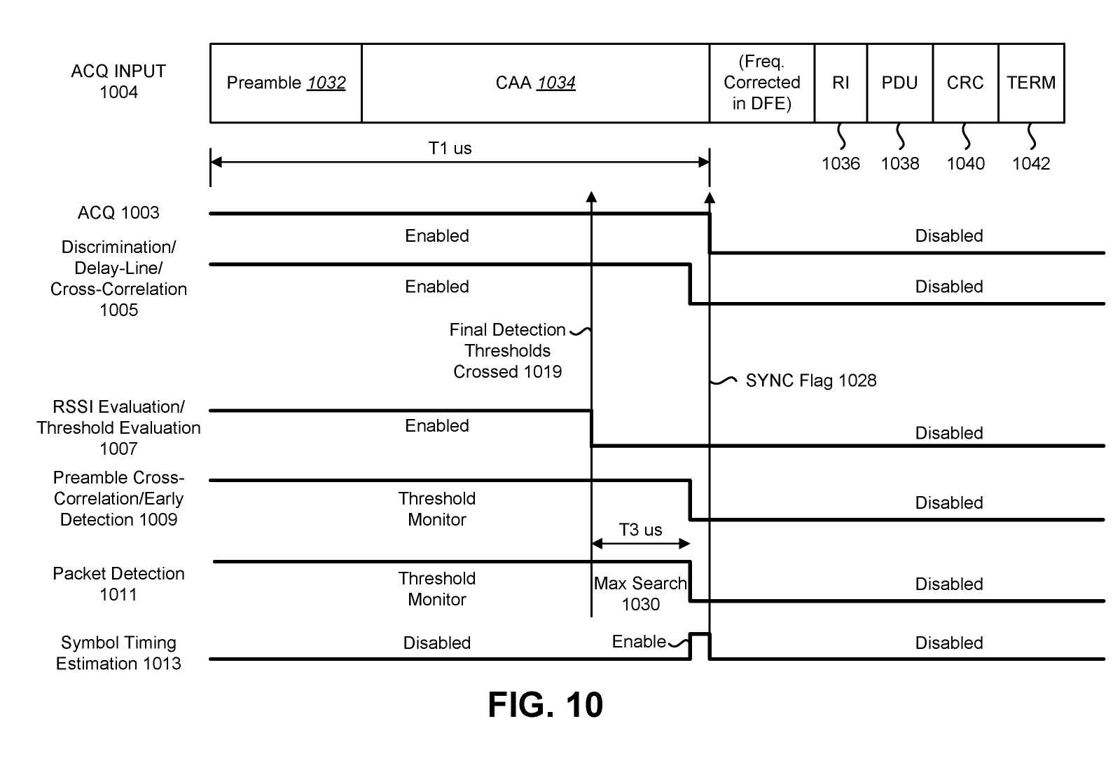

FIG. 10 is a timing diagram illustrating packet acquisition when a preamble 1032 is not detected. An acquisition (ACQ) input 1004 may be a BLR packet that includes a preamble 1032, CAA 1034, RI 1036, PDU 1038, a CRC 1040 and a TERM 1042.

The discrimination/delay-line/cross-correlation 1005 waveform corresponds to the activity of the discrimination/normalization block 750, the delay line 752 and the second cross-correlator 710. The RSSI evaluation/threshold evaluation 1007 waveform corresponds to the activity of the RSSI evaluation block 758 and the threshold evaluation block 770. The preamble cross-correlation/early detection 1009 waveform corresponds to the activity of the first cross correlator 706 and the preamble detector 714. The packet detection 1011 waveform corresponds to the activity of the packet detector 722. The symbol timing estimation 1013 waveform corresponds to the activity of the symbol timing estimation block 782.

Upon receiving the signal, packet acquisition (ACQ) 1003 is enabled for a certain period of time (T1 μs). Discrimination/delay-line/cross-correlation 1005 and RSSI evaluation/threshold evaluation 1007 are also enabled. Preamble cross-correlation/early detection 1009 and packet detection 1011 are enabled in a threshold monitor state. The symbol timing estimation 1013 is disabled.

In this example, the preamble cross-correlation/early detection 1009 fails to detect the preamble 1032. Therefore, both the preamble cross-correlation/early detection 1009 and packet detection 1011 continue in a threshold monitoring state until the final detection thresholds are crossed 1019. For example, the packet detector 722 may determine that the RSSI 760 crosses the RSSI threshold 124. The packet detector 722 may also determine that a given cross-correlation result crosses the one or more detection thresholds 126.

When the final detection thresholds are crossed 1019, the RSSI evaluation/threshold evaluation 1007 is disabled. The packet detection 1011 enters a maximum search phase 1030. For example, the packet detector 722 may start a packet search window 130 for a period of time (T3 μs).

At the end of the maximum search phase 1030, symbol timing estimation 1013 is enabled. The packet detector 722 may provide the maximum cross-correlation result position (crossedThreshCountMax) 780 to the symbol timing estimation block 782. Packet detection 1011, preamble cross-correlation/early detection 1009 and discrimination/delay-line/cross-correlation 1005 are then disabled.

The symbol timing estimation block 782 may determine a time estimate 784. A sync flag 1078 may indicate that a packet was detected. Symbol timing estimation 1013 and ACQ 1003 are then disabled.

FIG. 11 is a block diagram illustrating a configuration of an RSSI evaluation block 1158. The RSSI evaluation block 1158 may receive IQ samples 1148. An absolute value block 1186a may output the magnitude of the IQ samples 1148. The magnitude may be provided to a leaky integrator 1188a.

The leaky integrator 1188 may be an infinite impulse response (IIR) filter. An implementation of the leaky integrator 1188a is described in connection with FIG. 13. The magnitude of the IQ samples 1148 filtered over a configurable time window produces the RSSI 1160.

An additional metric iqAbsSigma 1162 is the averaged distance of the current magnitude from the average (RSSI) 1160. This estimates the deviation of the current IQ sample 1148 from RSSI 1160. In an implementation, the output of the leaky integrator 1188a is subtracted from the magnitude of the current IQ sample 1148 at an adder 1190 and provided to an absolute value block 1186b. The output of the absolute value block 1186b may be input into a second leaky integrator 1188b, which averages the deviation of the IQ samples 1148 from RSSI 1160.

FIG. 12 is a block diagram illustrating a configuration of a threshold evaluation block 1270. In this implementation, the threshold evaluation block 1270 evaluates two thresholds: threshMean 1272 and scaledThresh 1274 for use by the packet detector 122.

The cross-correlation result metric (corrResMetric) 1266 is averaged with a leaky integrator 1288. This may be accomplished as described in connection with FIG. 13. The output of the leaky integrator 1288 may be scaled by a value (threshMeanMult) 1201 at mixer 1203. The output of mixer 1203 is the first threshold (threshMean) 1272.

The second threshold (scaledThresh) 1274 is evaluated as a configurable fixed threshold (thresh) 1215 that is decreased by normalized deviation of IQ samples. In an implementation, the metric iqAbsSigma 1262 determined by the RSSI evaluation block 1158 is divided by the RSSI 1260 at a division (DIV) block 1207. The normalized deviation is further scaled by a configurable parameter threshSigmaMult 1265 at mixer 1213.

The normalized deviation output by the mixer 1213 is subtracted from the fixed threshold (thresh) 1215 at adder 1217. Therefore, a noisy IQ signal lowers the thresholds. If the ratio of iqAbsSigma/RSSI peaks above a configurable threshold (RSSIIQAbsSigmaMinRatio) 1209, the fixed threshold (thresh) 1215 is used instead. In an implementation, the output of the DIV block 1207 is compared with RSSIIQAbsSigmaMinRatio 1209 at a comparison block 1211. If the output of the DIV block 1207 is less than RSSIIQAbsSigmaMinRatio 1209, then the output of the comparison block 1211 is 1, otherwise the output is 0. A multiplexor 1219 outputs thresh 1215 decreased by the normalized deviation when the comparison block 1211 output is 1 and thresh 1215 when the comparison block 1211 output is 0.

The final threshold (scaledThresh) 1274 is low-saturated at a configurable minimum (minThresh) 1223. In an implementation, the output of the first multiplexor 1219 may be compared to the minThresh 1223 at a comparison block 1221. If the output of the first multiplexor 1219 is less than minThresh 1223, then a second multiplexor 1225 outputs minThresh 1223. Otherwise, the second multiplexor 1225 passes the output of the first multiplexor 1219 as the final threshold (scaledThresh) 1274.

FIG. 13 is a block diagram illustrating a configuration of a leaky integrator 1388. In one configuration, the leaky integrator 1388 may be implemented in an RSSI evaluation block 1158, as described in connection with FIG. 11. In another configuration, the leaky integrator 1388 may be implemented in a threshold evaluation block 1270, as described in connection with FIG. 12.

The leaky integrator 1388 may be an IIR filter configured to average over 2^{L} samples. The leaky integrator 1388 may have a configurable parameter L. In the case of RSSI, L may be a first integer (RSSIInt). In the case of threshold evaluation, L may be a second integer (ThreshInt).

The input to the leaky integrator 1388 may be summed with a feedback signal at an adder 1392a. The output of the adder 1392a may be provided to a unit delay 1396. The output of the unit delay 1396 may be provided to a second adder 1392b and a multiplier 1394a. The multiplier 1394a may multiply the output of the unit delay 1396 by a negative power of two (block 1398a). The multiplication can be accomplished by a signed shift due to a multiplication by a power of 2. The multiplication is always by a negative power of two which is equivalent to division by a power of 2. This could be implemented as signed right shift by L. The output of the multiplier 1394a is subtracted from the output of the unit delay 1396 at the second adder 1392b. The output of the second adder 1392b is provided to the first adder 1392a.

This implementation may act as a low-pass IIR filter, also known as a leaky integrator. A leaky integrator may be beneficial due to its simplicity, compared to an average of N samples which needs to store all N samples. Here only one state is stored, the output of the unit delay 1396.

The output of the first adder 1392a is also multiplied by a negative power of two (block 1398b) at a second multiplier 1394b. The output of the second multiplier 1394b is the output of the leaky integrator 1388.

FIG. 14 is a block diagram illustrating a configuration of a preamble detector 1414. The preamble detector 1414 may be implemented in accordance with the preamble detector 114 described in connection with FIG. 1 and the preamble detector 714 described in connection with FIG. 7. The preamble detector 1414 may perform preamble detection on a received signal 104 using a first set of cross-correlation results 108.

In an implementation, the cross-correlation results (corrResPreambleAbs) 1464 may be compared against a configurable threshold (earlyDetectionThresh) 1427 at a comparison block 1429. When corrResPreambleAbs 1464 is greater than the earlyDetectionThresh 1427, then the comparison output 1402 is set to 1. This comparison output 1402 triggers a register 1431 to store the value of corrResPreambleAbs 1464 at the first edge. Therefore, the first value 1404 of corrResPreambleAbs 1464 that crosses the earlyDetectionThresh 1427 is stored.

The comparison output 1402 also triggers a SET 1433 to set the output 1435 to 1. The value of the output 1435 is normally 0 unless triggered by the comparison output 1402. The output 1435 may be provided to an inverter 1471 (i.e., NOT gate) and the output of the inverter 1471 may be provided to an OR gate 1473.

The output of the OR gate 1473 is an enable detection signal (earlyDetectionEnableDetection) 1468 that enables or disables packet detection (by the packet detector 122, for instance). The packet detection is enabled when earlyDetectionEnableDetection 1468 is 1 and disabled when earlyDetectionEnableDetection 1468 is 0. Therefore, when corrResPreambleAbs 1464 crosses the earlyDetectionThresh 1427, packet detection is immediately disabled (e.g., earlyDetectionEnableDetection 1468=0).

The output 1435 may also be provided to a window counter 1437. When the output 1435 is set to 1, the window counter 1437 starts counting a configurable number of corrResPreambleAbs 1464 samples (earlyDetectionWinMaxSearch) 1457 corresponding to the preamble search window 118. The window counter 1437 may output a counter active signal 1439 to a max search block 1443. When the counter active signal 1439 is 1, the max search block 1443 searches the corrResPreambleAbs 1464 samples for a maximum value.

The max search block 1443 outputs the position (max count 1447) of the maximum corrResPreambleAbs 1464 to a multiplexor 1451. The max search block 1443 also outputs the maximum value 1445 of the corrResPreambleAbs 1464 samples to the adder 1432, which subtracts the first value 1404 of corrResPreambleAbs 1464 that crosses the earlyDetectionThresh 1427 from the maximum value 1445. When the output 1410 of the comparison block 1449 is 1, then the max count 1447 is output by the multiplexor 1451, otherwise, the earlyDetectionInitSymOffset 1450 is output.

The output 1406 of the adder 1432 is provided to a comparison block 1449. If the maximum value 1445 minus the first value 1404 is above a configurable offset (earlyDetectionThreshMaxOffset) 1408, then the waiting interval (i.e., delay window 120) to re-enable the packet detection logic is determined as max count 1447+y, where y=earlyDetectionWinSymOffset 1455−earlyDetectionWinMaxSearch 1457. Otherwise, the number of samples for the delay window 120 corresponds to earlyDetectionInitSymOffset 1450+y.

At the end of the preamble search window 118, the window counter 1437 outputs a counter end signal 1441 to a unit delay 1453. In FIG. 14, the “EN” on the unit delay 1453 refers to Enable of the unit delay 1453 (or register in other words), which only passes the value to the output when the window counter 1437 is at the last value of the count. The unit delay 1453 may pass the output of multiplexor 1451 at the end of the preamble search window 118 to an adder 1463. Another adder 1461 may calculate y which is added at adder 1463. The output of adder 1463 is the length of the delay window 120.

The length of the delay window 120 is provided to a counter 1465, which counts down from this value. While the counter 1465 is active, it outputs a count signal 1467 (set to 1) to a register 1469. While the register 1469 receives the count signal 1467, the register 1469 outputs a 0 to the OR gate 1473, thus disabling packet detection.

The counter 1465 saturates at zero, at which point the counter 1465 is reset. At reset, the counter 1465 is set to non-zero and the register 1469 is set to 1, re-enabling packet detection.

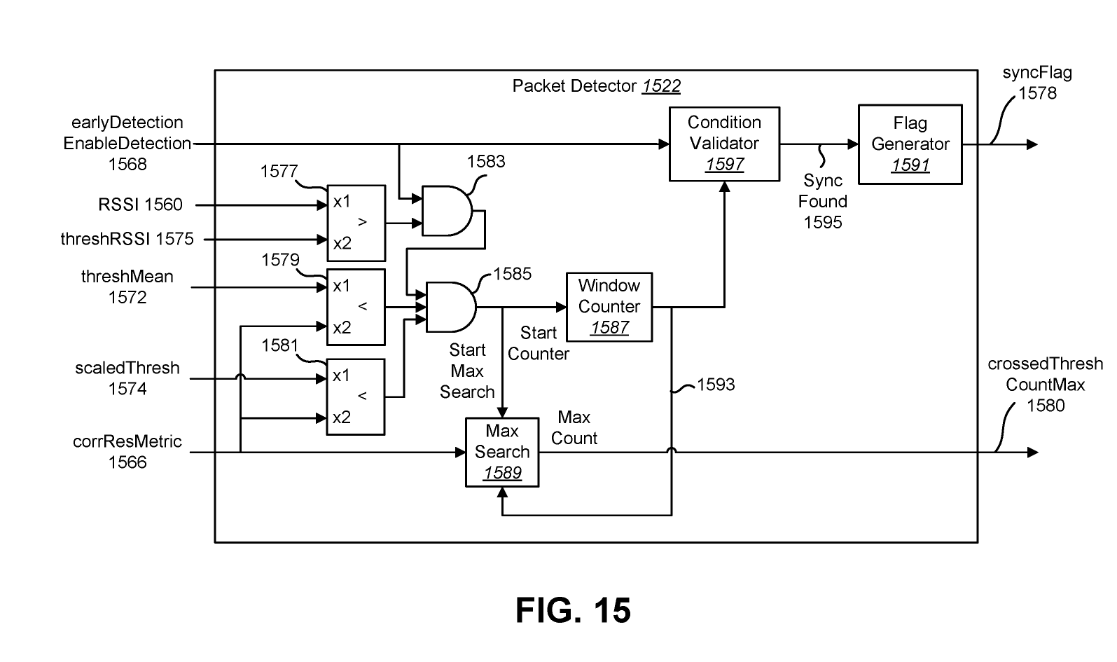

FIG. 15 is a block diagram illustrating a configuration of a packet detector 1522. The packet detector 1522 may be implemented in accordance with the packet detector 122 described in connection with FIG. 1 and the packet detector 722 described in connection with FIG. 7.

The packet detector 1522 may receive an enable detection signal (earlyDetectionEnableDetection) 1568. For example, the packet detector 1522 may receive the earlyDetectionEnableDetection 1568 from a preamble detector 1414 described in connection with FIG. 14. When earlyDetectionEnableDetection 1568 is 1, the packet detector 1522 is enabled. The earlyDetectionEnableDetection 1568 may be provided to an AND gate 1583.

The packet detector 1522 may receive an RSSI 1560 of the received signal 104. For example, the packet detector 1522 may receive the RSSI 1560 from an RSSI evaluation block 1158 described in connection with FIG. 11. A comparison block 1577 may compare the RSSI 1560 to an RSSI threshold (threshRSSI) 1575. If the RSSI 1560 is greater than threshRSSI 1575, then the comparison block 1577 outputs a 1 to the AND gate 1583.

The packet detector 1522 may also compare cross-correlation results (corrResMetric) 1566 to two detection thresholds: threshMean 1572 and scaledThresh 1574, as provided by the threshold evaluation block 1270 described in connection with FIG. 12. A second comparison block 1579 may compare threshMean 1572 with corrResMetric 1566. A third comparison block 1581 may compare scaledThresh 1574 with corrResMetric 1566. When corrResMetric 1566 crosses threshMean 1572 and scaledThresh 1574, the second comparison block 1579 and the third comparison block 1581 output a 1 to a second AND gate 1585. The packet is detected when the IQ samples have enough power (i.e., RSSI 1560>threshRSSI 1575) and the cross-correlation result is above both dynamic detection thresholds 1572, 1574 (i.e., corrResMetric 1566>threshMean 1572 & corrResMetric 1566>scaledThresh 1574). When these conditions are met, the AND gate 1585 outputs a 1.

The output of the AND gate 1585 is provided to a window counter 1587 and a maximum search block 1589. When the output of the AND gate 1585 is 1, this starts the window counter 1587 counting a number of samples in a packet search window 130. The maximum search block 1589 may also start searching for the maximum value of corrResMetric 1566. The maximum search block 1589 may store the position (i.e., max count) of the maximum corrResMetric 1566.

At the end of the packet search window 130, the window counter 1587 may send signal 1593 to the maximum search block 1589. Upon receiving the signal 1593, the maximum search block 1589 stops the search and outputs the position of the maximum corrResMetric 1566 as a crossedThreshCountMax 1580, which may be provided to a symbol timing estimation block 782.

The window counter 1587 may also send the signal 1593 to a condition validator 1597. When enabled (e.g., when earlyDetectionEnableDetection 1568 is 1), the condition validator 1597 outputs a sync found signal 1595 upon receiving the signal 1593 from the window counter 1587 indicating that the window counter 1587 was active. A flag generator 1591 may assert a sync flag (syncFlag) 1578 at the end of the packet search window 130. The syncFlag 1578 indicates that a packet was detected.

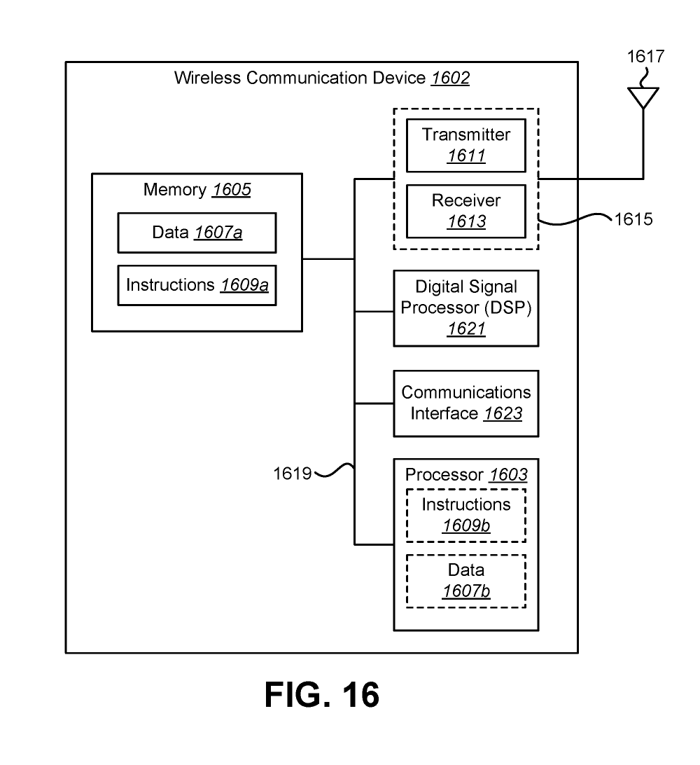

FIG. 16 illustrates certain components that may be included within a wireless communication device 1602. The wireless communication device 1602 described in connection with FIG. 16 may be an example of and/or may be implemented in accordance with the wireless communication device 102 described in connection with one or more of FIGS. 1-15.

The wireless communication device 1602 includes a processor 1603. The processor 1603 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1603 may be referred to as a central processing unit (CPU). Although just a single processor 1603 is shown in the wireless communication device 1602 of FIG. 16, in an alternative configuration, a combination of processors (e.g., an ARM and DSP) could be used.

The wireless communication device 1602 also includes memory 1605 in electronic communication with the processor 1603 (i.e., the processor can read information from and/or write information to the memory). The memory 1605 may be any electronic component capable of storing electronic information. The memory 1605 may be configured as Random Access Memory (RAM), Read-Only Memory (ROM), magnetic disk storage media, optical storage media, flash memory devices in RAM, on-board memory included with the processor, Erasable Programmable Read-Only Memory (EPROM), Electrically Erasable Programmable Read-Only Memory (EEPROM), registers and so forth, including combinations thereof.

Data 1607a and instructions 1609a may be stored in the memory 1605. The instructions 1609a may include one or more programs, routines, sub-routines, functions, procedures, code, etc. The instructions 1609a may include a single computer-readable statement or many computer-readable statements. The instructions 1609a may be executable by the processor 1603 to implement the methods disclosed herein. Executing the instructions 1609a may involve the use of the data 1607a that is stored in the memory 1605. When the processor 1603 executes the instructions 1609, various portions of the instructions 1609b may be loaded onto the processor 1603, and various pieces of data 1607b may be loaded onto the processor 1603.

The wireless communication device 1602 may also include a transmitter 1611 and a receiver 1613 to allow transmission and reception of signals to and from the wireless communication device 1602 via an antenna 1617. The transmitter 1611 and receiver 1613 may be collectively referred to as a transceiver 1615. The wireless communication device 1602 may also include (not shown) multiple transmitters, multiple antennas, multiple receivers and/or multiple transceivers.

The wireless communication device 1602 may include a digital signal processor (DSP) 1621. The wireless communication device 1602 may also include a communications interface 1623. The communications interface 1623 may allow a user to interact with the wireless communication device 1602.

The various components of the wireless communication device 1602 may be coupled together by one or more buses, which may include a power bus, a control signal bus, a status signal bus, a data bus, etc. For the sake of clarity, the various buses are illustrated in FIG. 16 as a bus system 1619.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for Bluetooth packet acquisition, comprising:
computing an absolute value of each sample in a first set of cross-correlation results of a received signal;
starting a preamble search window when the absolute value of a given sample crosses an early detection threshold indicating preamble detection;
determining a maximum cross-correlation result within the preamble search window;
disabling packet detection by a delay window when a preamble is detected; and
detecting the Bluetooth packet based on a maximum cross-correlation result of the received signal within a packet search window of a second set of cross-correlation results.

2. (canceled)

3. The method of claim 1, further comprising:
determining a length of the delay window based on a comparison of an initial cross-correlation result in the preamble search window and the maximum cross-correlation result in the preamble search window; and
re-enabling packet detection at the end of the delay window.

4. The method of claim 1, wherein detecting the Bluetooth packet comprises:
determining that a Received Signal Strength Indicator (RSSI) of the received signal is greater than an RSSI threshold; and
determining that a cross-correlation result of a given sample is greater than one or more detection thresholds.

5. The method of claim 4, wherein the one or more detection thresholds comprise a first detection threshold and a second detection threshold, the first detection threshold comprising the cross-correlation result of the given sample averaged with a leaky integrator, and the second detection threshold comprising a configurable fixed threshold decreased by a normalized deviation of in-phase and quadrature phase (IQ) components of the given sample.

6. The method of claim 1, wherein detecting the Bluetooth packet comprises:
starting the packet search window of the second set of cross-correlation results upon detecting the Bluetooth packet; and
determining a maximum cross-correlation result within the packet search window.

7. The method of claim 6, wherein the Bluetooth packet is determined to arrive at a time corresponding to the maximum cross-correlation result in the packet search window.

8. The method of claim 6, further comprising disregarding secondary peaks in the packet search window as false alarms.

9. The method of claim 1, further comprising providing a position of the maximum cross-correlation result in the packet search window to a symbol timing estimator to estimate initial symbol timing of the Bluetooth packet.

10. The method of claim 1, wherein the Bluetooth packet is a Bluetooth long range (BLR) packet or a Bluetooth Low Energy (BLE) packet.

11. A wireless communication device configured for Bluetooth packet acquisition, comprising:
a processor;
a memory in communication with the processor; and
instructions stored in the memory, the instructions executable by the processor to:
compute an absolute value of each sample in a first set of cross-correlation results of a received signal;
start a preamble search window when the absolute value of a given sample crosses an early detection threshold indicating preamble detection;
determine a maximum cross-correlation result within the preamble search window;
disable packet detection by a delay window when a preamble is detected; and
detect the Bluetooth packet based on a maximum cross-correlation result of the received signal within a packet search window of a second set of cross-correlation results.

12. (canceled)

13. The wireless communication device of claim 11, further comprising instructions executable to:
determine a length of the delay window based on a comparison of an initial cross-correlation result in the preamble search window and the maximum cross-correlation result in the preamble search window; and
re-enable packet detection at the end of the delay window.

14. The wireless communication device of claim 11, wherein the instructions executable to detect the Bluetooth packet comprise instructions executable to:
determine that a Received Signal Strength Indicator (RSSI) of the received signal is greater than an RSSI threshold; and
determine that a cross-correlation result of a given sample is greater than one or more detection thresholds.

15. The wireless communication device of claim 14, wherein the one or more detection thresholds comprise a first detection threshold and a second detection threshold, the first detection threshold comprising the cross-correlation result of the given sample averaged with a leaky integrator, and the second detection threshold comprising a configurable fixed threshold decreased by a normalized deviation of in-phase and quadrature phase (IQ) components of the given sample.

16. The wireless communication device of claim 11, wherein the instructions executable to detecting the Bluetooth packet comprise instructions executable to:
starting the packet search window of the second set of cross-correlation results upon detecting the Bluetooth packet; and
determining a maximum cross-correlation result within the packet search window.

17. The wireless communication device of claim 16, further comprising instructions executable to disregard secondary peaks in the packet search window as false alarms.

18. The wireless communication device of claim 11, further comprising instructions executable to provide a position of the maximum cross-correlation result in the packet search window to a symbol timing estimator to estimate initial symbol timing of the Bluetooth packet.

19. A computer-program product for Bluetooth packet acquisition, the computer-program product comprising a non-transitory computer-readable medium having instructions thereon, the instructions comprising:
code for causing a wireless communication device to compute an absolute value of each sample in a first set of cross-correlation results of a received signal;
code for causing the wireless communication device to start a preamble search window when the absolute value of a given sample crosses an early detection threshold indicating preamble detection;
code for causing the wireless communication device to determine a maximum cross-correlation result within the preamble search window;
code for causing the wireless communication device to disable packet detection by a delay window when a preamble is detected; and
code for causing the wireless communication device to detect the Bluetooth packet based on a maximum cross-correlation result of the received signal within a packet search window of a second set of cross-correlation results.

20. (canceled)

21. The computer-program product of claim 19, the instructions further comprising:
code for causing the wireless communication device to determine a length of the delay window based on a comparison of an initial cross-correlation result in the preamble search window and the maximum cross-correlation result in the preamble search window; and
code for causing the wireless communication device to re-enable packet detection at the end of the delay window.

22. The computer-program product of claim 19, wherein the code for causing the wireless communication device to detect the Bluetooth packet comprises:
code for causing the wireless communication device to determine that a Received Signal Strength Indicator (RSSI) of the received signal is greater than an RSSI threshold; and
code for causing the wireless communication device to determine that a cross-correlation result of a given sample is greater than one or more detection thresholds.

23. The computer-program product of claim 22, wherein the one or more detection thresholds comprise a first detection threshold and a second detection threshold, the first detection threshold comprising the cross-correlation result of the given sample averaged with a leaky integrator, and the second detection threshold comprising a configurable fixed threshold decreased by a normalized deviation of in-phase and quadrature phase (IQ) components of the given sample.

24. The computer-program product of claim 19, wherein the code for causing the wireless communication device to detect the Bluetooth packet comprises:
code for causing the wireless communication device to start the packet search window of the second set of cross-correlation results upon detecting the Bluetooth packet; and
code for causing the wireless communication device to determine a maximum cross-correlation result within the packet search window.

25. An apparatus configured for Bluetooth packet acquisition, comprising:
means for computing an absolute value of each sample in a first set of cross-correlation results of a received signal;
means for starting a preamble search window when the absolute value of a given sample crosses an early detection threshold indicating preamble detection;
means for determining a maximum cross-correlation result within the preamble search window;
means for disabling packet detection by a delay window when a preamble is detected; and
means for detecting the Bluetooth packet based on a maximum cross-correlation result of the received signal within a packet search window of a second set of cross-correlation results.

26. (canceled)

27. The apparatus of claim 25, further comprising:
means for determining a length of the delay window based on a comparison of an initial cross-correlation result in the preamble search window and the maximum cross-correlation result in the preamble search window; and
means for re-enabling packet detection at the end of the delay window.

28. The apparatus of claim 25, wherein the means for detecting the Bluetooth packet comprise:
means for determining that a Received Signal Strength Indicator (RSSI) of the received signal is greater than an RSSI threshold; and
means for determining that a cross-correlation result of a given sample is greater than one or more detection thresholds.

29. The apparatus of claim 28, wherein the one or more detection thresholds comprise a first detection threshold and a second detection threshold, the first detection threshold comprising the cross-correlation result of the given sample averaged with a leaky integrator, and the second detection threshold comprising a configurable fixed threshold decreased by a normalized deviation of in-phase and quadrature phase (IQ) components of the given sample.

30. The apparatus of claim 25, wherein the means for detecting the Bluetooth packet comprise:
means for starting the packet search window of the second set of cross-correlation results upon detecting the Bluetooth packet; and
means for determining a maximum cross-correlation result within the packet search window.
